(19) United States
(12) Patent Application Publication
(10) Pub. No.: US 2023/0362822 A1
(43) Pub. Date: Nov. 9, 2023

(54) SIGNALING OF PARAMETERS FOR A COMMUNICATION SCHEDULE

(71) Applicant: QUALCOMM Incorporated, San Diego, CA (US)

(72) Inventors: Alfred ASTERJADHI, San Diego, CA (US); Sai Yiu Duncan HO, San Diego, CA (US); George CHERIAN, San Diego, CA (US); Abhishek Pramod PATIL, San Diego, CA (US); Alireza RAISSINIA, Monte Sereno, CA (US); Padmanabhan Venkataraman KARTHIC, Chennai, TN (IN); James Simon CHO, Stateline, NV (US)

(21) Appl. No.: 17/922,949

(22) PCT Filed: Jun. 11, 2021
(86) PCT No.: PCT/US21/37109

§ 371 Date: Nov. 2, 2022

(30) Foreign Application Priority Data
Jun. 12, 2020 (IN) 202041024781

(51) Int. Cl. H04W 52/02

(52) U.S. Cl. CPC H04W 52/0258

(57) ABSTRACT

Aspects relate to signaling the parameters to be used for a communication schedule such as a target wake time (TWT) schedule. For example, a first wireless communication device (e.g., an access point or a peer station) may determine (e.g., specify or negotiate) the parameters for at least one TWT schedule and transmit a broadcast management frame (e.g., a beacon) that includes these parameters. A second wireless communication device (e.g., station) that receives the broadcast management frame may, based on the received parameters for one TWT schedule or the received parameters for multiple TWT schedules, elect to transmit during a transmission opportunity (TXOP) that is defined to not cross at least one boundary of a period of time indicated by the parameters.

### CROSS-REFERENCE TO RELATED APPLICATIONS

The present application for patent claims priority to and the benefit of pending India Provisional Patent Application No. 202041024781, titled “SIGNALING OF PARAMETERS FOR A NEGOTIATED COMMUNICATION SCHEDULE” filed Jun. 12, 2020, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to signaling the parameters for a communication schedule.

### INTRODUCTION

Wireless communication networks are widely deployed to provide various communication services. Some of these networks may be multiple access networks that support communication for multiple users by sharing available network resources. For example, a wireless communication device (e.g., a station) may communicate with another wireless communication device (e.g., an access point or a station) of a network to gain access to communication services provided by the network.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for wireless communication at a first wireless communication device is disclosed. The method may include receiving a broadcast management frame from a second wireless communication device. The broadcast management frame may include a first set of parameters for a first communication schedule. The method may also include transmitting information to the second wireless communication device during a transmission opportunity (TXOP) that is defined to not cross at least one boundary of a period of time indicated by the first set of parameters.

In some examples, a first wireless communication device may include a transceiver, a memory, and a processor coupled to the transceiver and the memory. The processor and the memory may be configured to receive a broadcast management frame from a second wireless communication device via the transceiver. The broadcast management frame may include a first set of parameters for a first communication schedule. The processor and the memory may also be configured to transmit information to the second wireless communication device via the transceiver during a transmission opportunity (TXOP) that is defined to not cross at least one boundary of a period of time indicated by the first set of parameters.

In some examples, a first wireless communication device may include means for receiving a broadcast management frame from a second wireless communication device. The broadcast management frame may include a first set of parameters for a first communication schedule. The first wireless communication device may also include means for transmitting information to the second wireless communication device during a transmission opportunity (TXOP) that is defined to not cross at least one boundary of a period of time indicated by the first set of parameters.

In some examples, an article of manufacture for use by a first wireless communication device includes a non-transitory computer-readable medium having stored therein instructions executable by one or more processors of the first wireless communication device to receive a broadcast management frame from a second wireless communication device. The broadcast management frame may include a first set of parameters for a first communication schedule. The computer-readable medium may also have stored therein instructions executable by one or more processors of the first wireless communication device to transmit information to the second wireless communication device during a transmission opportunity (TXOP) that is defined to not cross at least one boundary of a period of time indicated by the first set of parameters.

In some examples, a method for wireless communication at a first wireless communication device is disclosed. The method may include transmitting a broadcast management frame. The broadcast management frame may include a first set of parameters for a first communication schedule. The first set of parameters may define at least one service period. The method may also include receiving information from a second wireless communication device during a transmission opportunity (TXOP) that is defined to not cross at least one boundary of the at least one service period.

In some examples, a first wireless communication device may include a transceiver, a memory, and a processor coupled to the transceiver and the memory. The processor and the memory may be configured to transmit a broadcast management frame via the transceiver. The broadcast management frame may include a first set of parameters for a first communication schedule. The first set of parameters may define at least one service period. The processor and the memory may also be configured to receive information from a second wireless communication device via the transceiver during a transmission opportunity (TXOP) that is defined to not cross at least one boundary of the at least one service period.

In some examples, a first wireless communication device may include means for transmitting a broadcast management frame. The broadcast management frame may include a first set of parameters for a first communication schedule. The first set of parameters may define at least one service period. The first wireless communication device may also include means for receiving information from a second wireless communication device during a transmission opportunity (TXOP) that is defined to not cross at least one boundary of the at least one service period.

In some examples, an article of manufacture for use by a first wireless communication device includes a non-transitory computer-readable medium having stored therein instructions executable by one or more processors of the first wireless communication device to transmit a broadcast management frame. The broadcast management frame may include a first set of parameters for a first communication schedule. The first set of parameters may define at least one service period. The computer-readable medium may also have stored therein instructions executable by one or more processors of the first wireless communication device to receive information from a second wireless communication device during a transmission opportunity (TXOP) that is defined to not cross at least one boundary of the at least one service period.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a conceptual illustration of an example of a wireless communication system according to some aspects.

FIG. 2 is a block diagram of an example of a wireless communication device according to some aspects.

FIG. 3 is a block diagram of example components of the wireless communication device of FIG. 2 that may be used to transmit wireless communication signals according to some aspects.

FIG. 4 is a block diagram of example components of the wireless communication device of FIG. 2 that may be used to receive wireless communication signals according to some aspects.

FIG. 5 is a conceptual illustration of an example of target wait time (TWT) schedules according to some aspects.

FIG. 6 is a conceptual illustration of an example of TWT service periods according to some aspects.

FIG. 7 is a conceptual illustration of an example of an information element according to some aspects.

FIG. 8 is a conceptual illustration of an example of information elements in a beacon according to some aspects.

FIG. 9 is a signaling diagram of an example of signaling TWT parameters according to some aspects.

FIG. 10 is a block diagram conceptually illustrating an example of a hardware implementation for a wireless communication device employing a processing system according to some aspects.

FIG. 11 is a flow chart illustrating an example wireless communication process for signaling TWT parameters according to some aspects.

FIG. 12 is a block diagram conceptually illustrating an example of a hardware implementation for a wireless communication device employing a processing system according to some aspects of the disclosure.

FIG. 13 is a flow chart illustrating another example wireless communication process for signaling TWT parameters according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, end-user devices, etc., of varying sizes, shapes, and constitution.

Various aspects of the disclosure relate to signaling the parameters for a communication schedule such as a target wake time (TWT) schedule. For example, a wireless communication device such as an access point may determine (e.g., specify or negotiate) the parameters for at least one TWT schedule and transmit a broadcast management frame (e.g., a beacon) that includes these parameters. A station (STA) that receives the broadcast management frame may select a TWT to use or perform other operations (e.g., elect to change a TWT schedule or elect to request a new TWT schedule) based on the parameters specified for one TWT schedule or the parameters specified for multiple TWT schedules.

In some examples, an access point negotiates with different STAs operating under the access point (e.g., STAs in a basic service set of the access point) to define a set of TWT schedules. The access point may then transmit a corresponding parameter set for each TWT schedule in a beacon and/or transmit parameters for a broadcast TWT schedule (e.g., a TWT schedule that is defined for a group of STAs under the access point) in the beacon. A parameter set for a particular TWT schedule may include, for example, a start time of a service period, a duration of the service period, and a periodicity of the service period. A parameter set for a particular TWT schedule may also include, for example, information regarding the use of the service period by STAs operating under the access point. This usage information for a given TWT schedule may indicate, for example, how many STAs are being served, the type of traffic being transmitted, the percentage of resources that are being used, the percentage of time that it is possible to access the service period within a defined period of time, or any combination thereof.

In some examples, a STA that receives the parameter sets for the TWT schedules may decide which TWT schedule to use based on the usage information in the parameter sets. For example, the STA may select a particular TWT schedule if the number of stations using that TWT schedule is relatively low, if the type of traffic being transmitted has a low priority and/or a low data rate, if the percentage of resources being used is relatively low, if the percentage of time that it is possible to access the service period within a defined period of time is relatively high, or any combination thereof.

In some examples, a STA that receives the parameter sets for the TWT schedules may request a new TWT schedule from the access point based on the usage information in the parameter sets. For example, the STA may determine that it would be better served by a new TWT schedule if, for all of the TWT schedules indicated by the beacon, the number of stations using each TWT schedule is relatively high, the type of traffic being transmitted has a high priority and/or a high data rate, the percentage of resources being used is relatively high, the percentage of time that it is possible to access the service period within a defined period of time is relatively low, or any combination thereof.

In some examples, a STA that receives the parameter sets for the TWT schedules may modify (or request the access point to modify) a TWT schedule based on the usage information in one or more of the parameter sets. In some examples, modification of a TWT schedule may include a change in the timing of the service period, a change in the frequency bands allocated for the TWT schedule, a change in the spatial resources allocated for the TWT schedule, or any combination thereof. For example, the STA may determine that it would be better served by a modified TWT schedule if the number of stations using that TWT schedule is relatively high, if the type of traffic being transmitted has a high priority and/or a high data rate, if the percentage of resources being used is relatively high, if the percentage of time that it is possible to access the service period within a defined period of time is relatively low, or any combination thereof.

In some examples, a STA may specify or request that a transmission opportunity (TXOP) used by the STA to transmit to another wireless communication device (e.g., an access point or another STA) does not cross at least one boundary of a period of time (e.g., a service period) indicated by a parameter set for a TWT schedule. In some examples, a STA that has been transmitting during a TXOP may end its transmissions at such a boundary (e.g., if the TXOP as originally scheduled extends beyond the boundary).

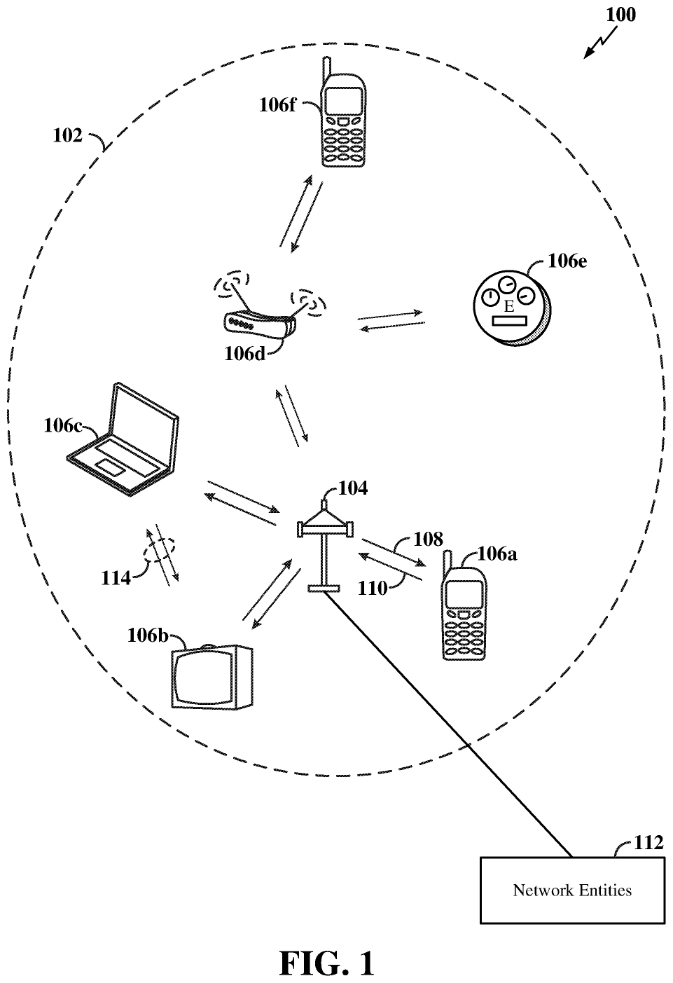

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. In some examples, the wireless communication system 100 may operate pursuant to a wireless communication standard, for example, the Institute of Electrical and Electronics Engineers (IEEE) 802.11 standard.

An access point (AP) 104 may be deployed in a network to provide access to one or more services (e.g., network connectivity) for one or more stations (STAs) such as the STAs 106a, 106b, 106c, 106d, 106e, and 106f (which may be referred to herein collectively as STAs 106 or separately as a STA 106) that may be installed within or that may roam throughout a coverage area of the network. Thus, at various points in time, a STA 106 may connect to the AP 104 or to some other access point in the network (not shown). In some examples, the AP 104 may be referred to as an AP STA. In some examples, the STAs 106 may be referred to as non-AP STAs.

A variety of processes and methods may be used for transmissions in the wireless communication system 100 between the AP 104 and the STAs 106. For example, signals may be sent and received between the AP 104 and the STAs 106 in accordance with orthogonal frequency-division multiplexing (OFDM) and orthogonal frequency-division multiple access (OFDMA) techniques. In this the case, the wireless communication system 100 may be referred to as an OFDM/OFDMA system. However, within the scope of the disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel. Other terminology may be used for these links in other examples.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS).

The AP 104 and each STA 106 may exchange data units that can include control information and/or data. At the physical (PHY) layer, such a data unit may be referred to as a physical layer protocol data unit (PPDU). In some aspects, a PPDU may be referred to as a packet or physical layer packet. Each PPDU may include a preamble and a payload. The preamble may include at least one training fields and at least one signaling (SIG) field. The payload may include a Media Access Control (MAC) header or data for other layers, and/or user data, for example. The payload may be transmitted using one or more data symbols. The systems, methods, and devices herein may utilize data units with training fields whose peak-to-power ratio has been minimized.

The wireless communication system 100 may employ methods to allow efficient access of the wireless communication medium based on unpredictable data transmissions while avoiding collisions. For example, to gain access to a channel, a device in the wireless communication system 100 may support a medium access control (MAC) distributed coordination function (DCF) that employs a carrier sense multiple access/collision avoidance (CSMA/CA) procedure. Other types of access schemes may be used in other examples. More generally, a device (e.g., an AP or a STA) having data for transmission senses the wireless communication medium to determine if the channel is already occupied. If the device senses the channel is idle, the device may transmit its data. Otherwise, the device may defer for some period before determining again whether or not the wireless communication medium is free for transmission. A method for performing a CSMA/CA procedure may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than a transmission that must wait longer before attempting to access the channel.

Some wireless communication systems (e.g., based on IEEE 802.11ax) employ a target wait time (TWT) mechanism that schedules STAs to transmit or receive on a wireless communication medium at certain times. This allows a STA to switch to a low power mode when the STA is not actively transmitting or receiving information. Thus, the STA may save power (outside of its scheduled transmit or receive times). In addition, the use of TWT scheduling may enable the BSS (e.g., an AP) to manage traffic more efficiently (e.g., by preventing communication collisions between STAs, by prioritizing traffic, and so on).

In some examples (e.g., if one or more of the STAs 106e and 106f are out of the range of the AP 104 or otherwise have difficulty communicating with the AP 104), a STA 106d may be configured as a relay device. For example, the STA 106d may be configured as a relay device (e.g., a device including STA and AP functionality) that relays communication between the AP 104 and the STA 106e and relays communication between the AP 104 and the STA 106f.

In some implementations, a wireless communication network might not have a central AP 104, but rather may function as a peer-to-peer network between the STAs 106. Accordingly, the functions of the AP 104 described herein may be performed by one or more of the STAs 106 in some examples. Also, in some examples, a STA may connect to a network served by an AP and also establish a peer-to-peer network with another STA.

For example, the STA 106b may communicate with the STA 106c via signaling 114 to form a peer-to-peer network. In this case, the STAs 106b and 106c may be referred to as a peer STAs. In some examples, the communication between the STAs 106b and 106c may operate pursuant to a wireless communication standard (e.g., the IEEE 802.11 standard or some other standard). For example, a first peer STA that has data to transmit to a second peer STA may perform a CSMA/CA procedure to gain access to a channel. In addition, the peer STAs may transmit data units that conform to the 802.11 standard (e.g., the data units include headers and payloads that conform to a specific version of the standard).

Access points in a network may communicate with one or more network entities (represented, for convenience, by network entities 112 in FIG. 1), including each other, to facilitate wide area network connectivity. A network entity may take various forms such as, for example, one or more radio and/or core network entities. Thus, in various implementations the network entities 112 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

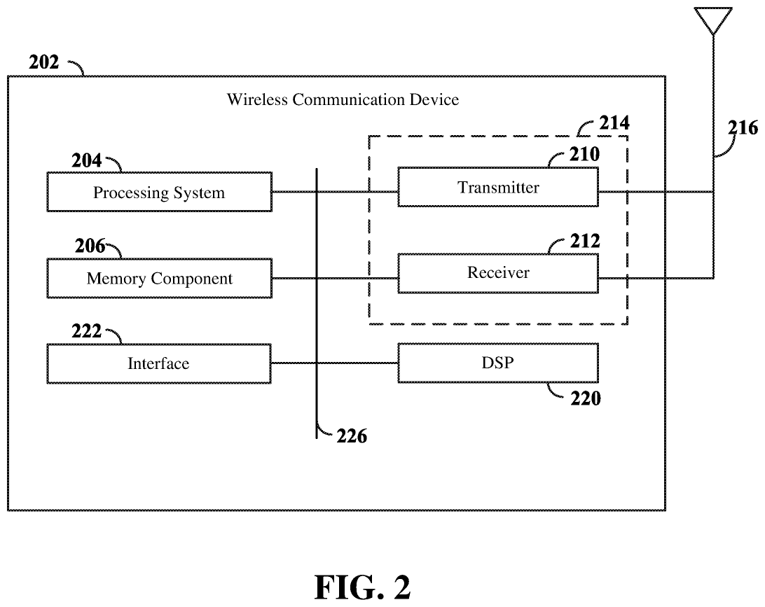

FIG. 2 illustrates several components of a wireless communication device 202 that may be deployed within the wireless communication system 100. The device 202 is an example of a device that may be configured to implement the various methods described herein. For example, the device 202 may be implemented as the AP 104, a relay (e.g., the STA 106d), or one of the STAs 106 of FIG. 1.

The device 202 may include a processing system 204 that controls operation of the device 202. The processing system 204 may also be referred to as a central processing unit (CPU). A memory component 206 (e.g., including a memory device), which may include both read-only memory (ROM) and random access memory (RAM), provides instructions and data to the processing system 204. A portion of the memory component 206 may also include non-volatile random access memory (NVRAM). The processing system 204 typically performs logical and arithmetic operations based on program instructions stored within the memory component 206. The instructions in the memory component 206 may be executable to implement the methods described herein.

When the device 202 is implemented or used as a transmitting node, the processing system 204 may be configured to select one of a plurality of media access control (MAC) header types, and to generate a packet having that MAC header type. For example, the processing system 204 may be configured to generate a packet including a MAC header and a payload and to determine what type of MAC header to use.

When the device 202 is implemented or used as a receiving node, the processing system 204 may be configured to process packets of a plurality of different MAC header types. For example, the processing system 204 may be configured to determine the type of MAC header used in a packet and process the packet and/or fields of the MAC header.

The processing system 204 may include or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The device 202 may also include a housing that may include a transmitter 210 and a receiver 212 to allow transmission and reception of data between the device 202 and a remote location. The transmitter 210 and receiver 212 may be combined into single communication device (e.g., a transceiver 214). In some implementations (e.g., where the transceiver 214 is an RF transceiver), an antenna 216 may be attached to the housing and electrically coupled to the transceiver 214. The device 202 may also include (not shown) multiple transmitters, multiple receivers, multiple transceivers, and/or multiple antennas. A transmitter 210 and a receiver 212 may be implemented as an integrated device (e.g., embodied as a transmitter circuit and a receiver circuit of a single communication device) in some implementations, may be implemented as a separate transmitter device and a separate receiver device in some implementations, or may be embodied in other ways in other implementations.

The transmitter 210 may be configured to wirelessly transmit packets according to one or more MAC header types (e.g., corresponding to different versions of the 802.11 standard). For example, the transmitter 210 may be configured to transmit packets with the type of header generated by the processing system 204, discussed above.

The receiver 212 may be configured to wirelessly receive packets having one or more MAC header types. In some aspects, the receiver 212 is configured to detect a particular type of a MAC header and process the packet accordingly.

The receiver 212 may be used to detect and quantify the level of signals received by the transceiver 214. The receiver 212 may detect such signals as total energy, energy per subcarrier per symbol, power spectral density and other signals. The device 202 may also include a digital signal processor (DSP) 220 for use in processing signals. The DSP 220 may be configured to generate a data unit for transmission. In some aspects, the data unit may include (e.g., may be) a physical layer data unit (PPDU). In some aspects, the PPDU is referred to as a packet.

The device 202 may further include an interface 222. In examples where the interface 222 is a user interface, the interface 222 may include (e.g., may be) a keypad, a microphone, a speaker, and/or a display. Such a user interface may include any element or component that conveys information to a user of the device 202 and/or receives input from the user.

The various components of the device 202 may be coupled together by a bus system 226. The bus system 226 may include a data bus, for example, as well as a power bus, a control signal bus, and a status signal bus in addition to the data bus. Those of skill in the art will appreciate the components of the device 202 may be coupled together or accept or provide inputs to each other using some other mechanism.

In some examples, the device 202 may be an integrated circuit. In some aspects, the device 202 may be configured to operate in a wireless communication node (e.g., an AP or a STA) and to perform one or more of the operations described herein. For convenience, a wireless communication node may be referred to herein as a wireless node.

In some implementations, the device 202 communicates with at least one other component (e.g., a component external to the apparatus) of the apparatus 200. To this end, in some implementations, the interface 222 (e.g., a send/receive interface) may be coupled to the processing system 204 for outputting and/or obtaining (e.g., sending and/or receiving) information (e.g., received information, generated information, decoded information, messages, etc.) between the processing system 204 and the other component. In some implementations, the interface 222 may include an interface bus, bus drivers, bus receivers, other suitable circuitry, or a combination thereof. In some implementations, the interface 222 may include radio frequency (RF) circuitry (e.g., an RF transmitter and/or an RF receiver). In some implementations, the interface 222 may be configured to interface the device 202 to one or more other components external to the apparatus 200 (other components not shown in FIG. 2). For example, the interface 222 may be configured to interface the processing system 204 to a radio frequency (RF) front end (e.g., an RF transmitter and/or an RF receiver).

The device 202 may communicate with other apparatuses in various ways. In some examples, the apparatus may transmit and receive information (e.g., a frame, a message, bits, etc.) via RF signaling. In some cases, rather than transmitting information via RF signaling, the device 202 may have an interface to provide (e.g., output, send, transmit, etc.) information for RF transmission. For example, the processing system 204 may output information, via a bus interface, to an RF front end for RF transmission. Similarly, rather than receiving information via RF signaling, the device 202 may have an interface to obtain information that is received by another apparatus. For example, the processing system 204 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

Although a number of separate components are illustrated in FIG. 2, one or more of the components may be combined or commonly implemented. For example, the processing system 204 may be used to implement not only the functionality described above with respect to the processing system 204, but also to implement the functionality described above with respect to the transceiver 214 and/or the DSP 220. Further, each of the components illustrated in FIG. 2 may be implemented using a plurality of separate elements. Furthermore, the processing system 204 may be used to implement any of the components, modules, circuits, or the like described below, or each may be implemented using a plurality of separate elements.

The components of FIG. 2 may be implemented in various ways. In some implementations, the components of FIG. 2 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 2 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

For ease of reference, when discussing the device 202 configured as a transmitting node, it may be hereinafter referred to as a device 202t Similarly, when discussing the device 202 configured as a receiving node, it may be hereinafter referred to as a device 202r. A device in the wireless communication system 100 may implement only functionality of a transmitting node, only functionality of a receiving node, or functionality of both a transmitting node and a receive node.

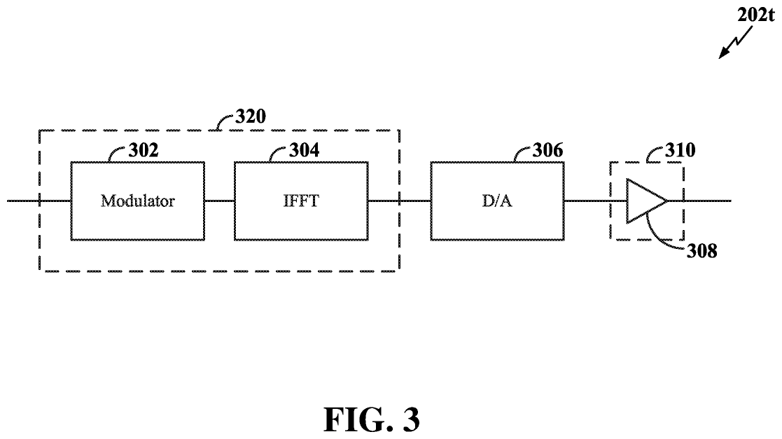

FIG. 3 illustrates various components that may be utilized in the device 202t to transmit wireless communication. The components illustrated in FIG. 3 may be used, for example, to transmit OFDM communication. In some examples, the components illustrated in FIG. 3 are used to generate and transmit packets to be sent over a bandwidth of less than or equal to 1 MHz. In some examples, the components illustrated in FIG. 3 are used to generate and transmit packets to be sent over a bandwidth of greater than or equal to 1 MHz.

The device 202t of FIG. 3 may include a modulator 302 configured to modulate bits for transmission. For example, the modulator 302 may determine a plurality of symbols from bits received from the processing system 204 (FIG. 2) or the interface 222 (FIG. 2), for example by mapping bits to a plurality of symbols according to a constellation. The bits may correspond to user data or to control information. In some aspects, the bits are received in codewords. In one example, the modulator 302 may include (e.g., may be) a QAM (quadrature amplitude modulation) modulator, for example, a 16-QAM modulator or a 64-QAM modulator. In other examples, the modulator 302 may include (e.g., may be) a binary phase-shift keying (BPSK) modulator, a quadrature phase-shift keying (QPSK) modulator, or an 8-PSK modulator. Other types of modulators may be used in other examples.

The device 202t may further include a transform module 304 configured to convert symbols or otherwise modulated bits from the modulator 302 into a time domain. In FIG. 3, the transform module 304 is illustrated as being implemented by an inverse fast Fourier transform (IFFT) module. Other types of transform modules may be used in other examples. In some implementations, there may be multiple transform modules (not shown) that transform units of data of different sizes. In some implementations, the transform module 304 may be itself configured to transform units of data of different sizes. For example, the transform module 304 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 24 points are used to convert symbols being transmitted over 24 tones into a time domain. The number of points used by the transform module 304 may be referred to as the size of the transform module 304.

In FIG. 3, the modulator 302 and the transform module 304 are illustrated as being implemented in the DSP 320. In some aspects, however, one or both of the modulator 302 and the transform module 304 are implemented in the processing system 204 or in another element of the device 202t (e.g., see description above with reference to FIG. 2).

As discussed above, the DSP 320 may be configured to generate a data unit for transmission. In some aspects, the modulator 302 and the transform module 304 may be configured to generate a data unit including a plurality of fields including control information and a plurality of data symbols.

The device 202t may further include a digital to analog converter (D/A) 306 configured to convert the output of the transform module into an analog signal. For example, the time-domain output of the transform module 304 may be converted to a baseband OFDM signal by the digital to analog converter 306. The digital to analog converter 306 may be implemented in the processing system 204 or in another element of the device 202 of FIG. 2. In some aspects, the digital to analog converter 306 is implemented in the transceiver 214 (FIG. 2) or in a data transmit processor.

The analog signal may be wirelessly transmitted by the transmitter 310. The analog signal may be further processed before being transmitted by the transmitter 310, for example by being filtered or by being upconverted to an intermediate or carrier frequency. In the aspect illustrated in FIG. 3, the transmitter 310 includes a transmit amplifier 308. Prior to being transmitted, the analog signal may be amplified by the transmit amplifier 308. In some aspects, the amplifier 308 may include a low noise amplifier (LNA).

The transmitter 310 is configured to transmit one or more packets or data units in a wireless signal based on the analog signal. The data units may be generated using the processing system 204 (FIG. 2) and/or the DSP 320, for example using the modulator 302 and the transform module 304 as discussed above. Data units that may be generated and transmitted as discussed above are described in additional detail herein.

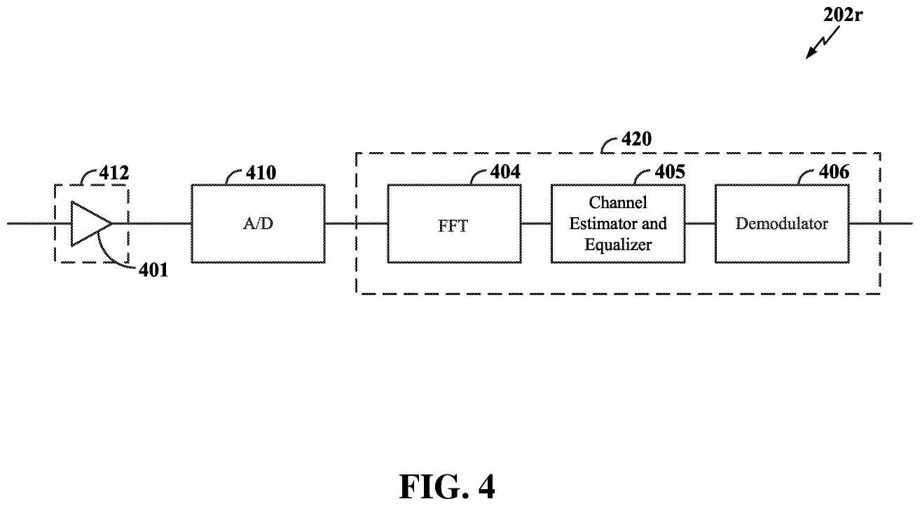

FIG. 4 illustrates various components that may be utilized in the device 202r to receive wireless communication. The components illustrated in FIG. 4 may be used, for example, to receive OFDM communication. For example, the components illustrated in FIG. 4 may be used to receive data units transmitted by the components discussed above with respect to FIG. 3.

The receiver 412 of device 202r is configured to receive one or more packets or data units in a wireless signal. Data units that may be received and decoded or otherwise processed as discussed below.

In the aspect illustrated in FIG. 4, the receiver 412 includes a receive amplifier 401. The receive amplifier 401 may be configured to amplify the wireless signal received by the receiver 412. In some aspects, the receiver 412 is configured to adjust the gain of the receive amplifier 401 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 401 may include an LNA.

The device 202r may include an analog to digital converter (A/D) 410 configured to convert the amplified wireless signal from the receiver 412 into a digital representation thereof. Further to being amplified, the wireless signal may be processed (e.g., by the receiver 412) before being converted by the analog to digital converter 410, for example by being filtered or by being downconverted to an intermediate or baseband frequency. The analog to digital converter 410 may be implemented in the processing system 204 (FIG. 2) or in another element of the device 202r. In some aspects, the analog to digital converter 410 is implemented in the transceiver 214 (FIG. 2) or in a data receive processor.

The device 202r may further include a transform module 404 configured to convert the representation of the wireless signal into a frequency spectrum. In FIG. 4, the transform module 404 is illustrated as being implemented by a fast Fourier transform (FFT) module. In some aspects, the transform module may identify a symbol for each point that it uses. As described above with reference to FIG. 3, the transform module 404 may be configured with a plurality of modes, and may use a different number of points to convert the signal in each mode. The number of points used by the transform module 404 may be referred to as the size of the transform module 404. In some aspects, the transform module 404 may identify a symbol for each point that it uses. Other types of transform modules may be used in other examples.

The device 202r may further include a channel estimator and equalizer 405 configured to form an estimate of the channel over which the data unit is received, and to remove certain effects of the channel based on the channel estimate. For example, the channel estimator and equalizer 405 may be configured to approximate a function of the channel, and the channel equalizer may be configured to apply an inverse of that function to the data in the frequency spectrum.

The device 202r may further include a demodulator 406 configured to demodulate the equalized data. For example, the demodulator 406 may determine a plurality of bits from symbols output by the transform module 404 and the channel estimator and equalizer 405, for example by reversing a mapping of bits to a symbol in a constellation. The bits may be processed or evaluated by the processing system 204 (FIG. 2), or used to display or otherwise output information to the interface 222 (FIG. 2). In this way, data and/or information may be decoded. In some aspects, the bits correspond to codewords. In one aspect, the demodulator 406 may include a QAM (quadrature amplitude modulation) demodulator, for example an 8-QAM demodulator or a 64-QAM demodulator. In other aspects, the demodulator 406 may include a binary phase-shift keying (BPSK) demodulator or a quadrature phase-shift keying (QPSK) demodulator. Other types of demodulators may be used in other examples.

In FIG. 4, the transform module 404, the channel estimator and equalizer 405, and the demodulator 406 are illustrated as being implemented in the DSP 420. In some aspects, however, one or more of the transform module 404, the channel estimator and equalizer 405, and the demodulator 406 are implemented in the processing system 204 (FIG. 2) or in another element of the device 202 (FIG. 2).

As discussed above, the wireless signal received at the receiver 212 may include one or more data units. Using the functions or components described above, the data units or data symbols therein may be decoded evaluated or otherwise evaluated or processed. For example, the processing system 204 (FIG. 2) and/or the DSP 420 may be used to decode data symbols in the data units using the transform module 404, the channel estimator and equalizer 405, and the demodulator 406.

The device 202t shown in FIG. 3 is an example of a single transmit chain used for transmitting via an antenna. The device 202r shown in FIG. 4 is an example of a single receive chain used for receiving via an antenna. In some implementations, the device 202t or 202r may implement a portion of a multiple-input multiple-output (MIMO) system using multiple antennas to simultaneously transmit data via multiple streams and/or receive simultaneously transmit data via multiple streams.

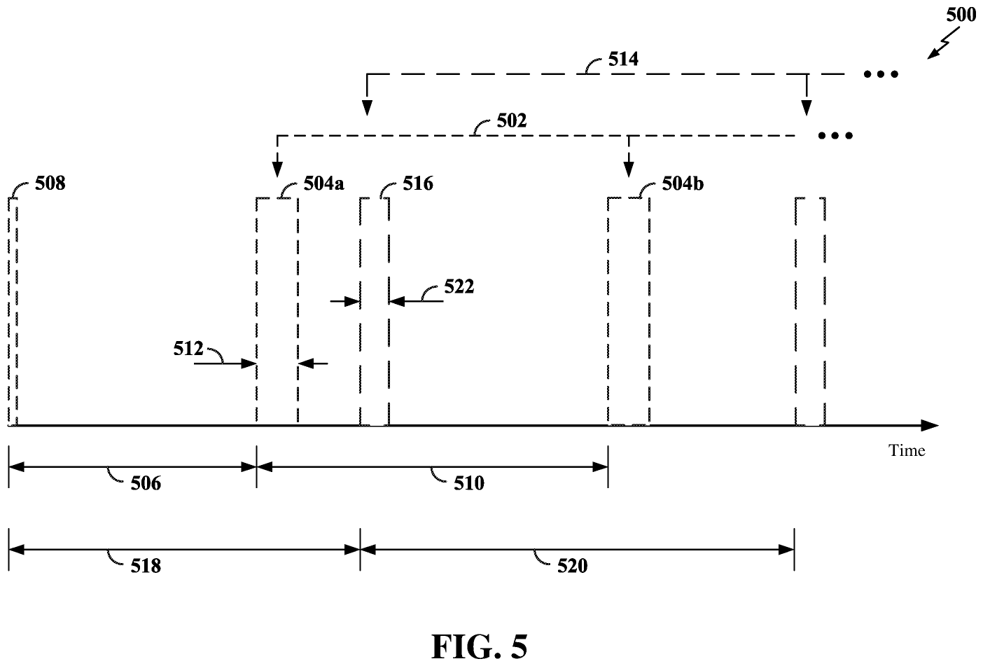

As mentioned above, a target wait time (TWT) mechanism may be used to schedules STAs to transmit or receive on a wireless communication medium at certain times. FIG. 5 illustrates an example of TWT scheduling 500. Here, a first TWT schedule specifies a first set of TWT service periods (indicated by a dashed line 502) where a first TWT service period 504a occurs a first defined period of time 506 after a beacon transmission 508 by an access point, and subsequent TWT service periods follow according to a first defined interval 510. For example, a second TWT service period 504b specified by the first TWT schedule follows the first TWT service period 504a by the defined interval 510. In addition, each TWT service period of the first TWT schedule may have a first defined duration 512.

Similarly, a second TWT schedule specifies a second set of TWT service periods (indicated by a dashed line 514) where a first TWT service period 516 of the second set occurs a second defined period of time 518 after the beacon transmission 508 by the access point, and subsequent TWT service periods follow according to a second defined interval 520. In addition, each TWT service period of the second TWT schedule may have a second defined duration 522. Other TWT schedules (not shown in FIG. 5) may be defined as well.

In some examples, wireless communication devices (e.g., a STA and an access point or a set of peer STAs) may negotiate to determine the parameters for a particular TWT schedule. For example, one or more of these devices may advertise the parameters (e.g., duration, periodicity, etc.) it would prefer to use. As another example, one of the devices (e.g., the access point or the STA) may send a request to use a particular set of parameters for a TWT schedule. In response to such a request, the other device (e.g., a STA or an access point) may accept the request, modify the request, or reject the request. Once the devices agree on the parameters to be used for the TWT schedule, the devices may commence communicating with one another according to the TWT schedule.

A STA that is configured for TWT scheduling may thus follow a particular schedule specified by one or more TWT parameters. For example, a STA may be expected to transmit within a particular scheduled service period of a TWT schedule and not transmit outside of that scheduled service period. In some examples, a device (e.g., an AP or a peer STA) may assist a STA in accessing the wireless communication medium by transmitting trigger frames (e.g., that specify when certain STAs are to transmit).

In some examples, a STA may be expected to not contend for access of a wireless communication medium on its own (e.g., without a trigger frame or outside of a TWT service period). However, the STA might not be required to refrain from contending for access. Thus, in some scenarios, a STA may contend for access of such a wireless communication medium.

A STA may contend for such access using an enhanced distributed channel access (EDCA) procedure or some other suitable medium access contention procedure. In some examples, a STA may use baseline EDCA parameters to control how the STA accesses the wireless communication medium. For example, an EDCA parameter may define a counter used by a STA to delay access to the wireless communication medium for a period of time (e.g., where the delay period may change over time according to defined criteria). In some examples, a STA may use multi-user (MU) EDCA parameters (e.g., defined for a group of users). In some aspects, the MU EDCA parameters may provide lower priority and/or may be enabled when a STA responds to certain trigger frames.

In view of the above, a STA configured for TWT scheduling might not have stringent requirements for accessing a wireless communication medium according to the TWT allocations. For example, there might be only a recommendation that the STA not access a wireless communication medium (as opposed to a requirement that the STA not access the wireless communication medium). In addition, a STA might not know how many STAs are using a given TWT service period (e.g., for a given TWT schedule). Consequently, the scheduling performance achieved using such TWT scheduling mechanisms might be suboptimal.

The disclosure relates in some aspects to improving wireless communication performance by providing more stringent rules for STAs when contending for a wireless communication medium. For example, these rules may be applicable within a STA's scheduled service periods and/or outside of the STA's scheduled service periods.

The disclosure relates in some aspects to improving scheduling performance by providing STAs with statistics (or other information) relating to the use of the service periods. For example, a STA may use this information to select a TWT schedule that the STA will use for communicating with an access point or peer STA.

In some examples, the following access rules may be applicable for a STA that subscribes to (e.g., agrees to use) a TWT schedule. A STA that has subscribed to a TWT schedule may be required to follow MU EDCA parameters when contending for a wireless communication medium outside of the TWT service periods. In some examples, MU EDCA parameters may provide lower (or higher) priority with respect to a baseline EDCA and/or may disable access altogether. Conversely, a STA that has subscribed to a TWT schedule may be required to follow TWT EDCA parameters (or baseline EDCA parameters) when contending for a wireless communication medium within the TWT service periods.

In some examples, the following access rules may be applicable for a STA when transitioning from operation within a TWT service period to operation outside of a TWT service period, or vice versa. Previously used EDCA counters may be suspended or reset. In addition, new EDCA counters may be resumed or reset.

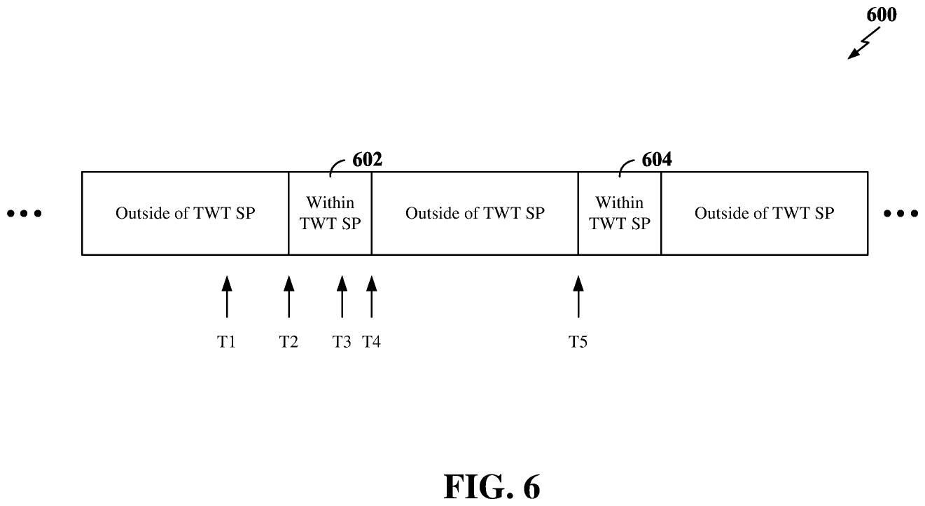

Referring to the TWT service period (SP) diagram 600 of FIG. 6, an example of a counter suspension procedure will be described. FIG. 6 illustrates a first TWT service period (SP) 602, a second TWT service period (SP) 604, and periods of time that are outside of these TWT service periods. When a STA is operating outside of the first TWT service period (SP) 602, the STA may use EDCA to contend for a wireless communication medium. Accordingly, at time T1 the STA may start a first EDCA counter that is used to determine when the STA may attempt to access the wireless communication medium outside of a TWT service period. If, at time T2, the STA commences operation within a TWT service period while the first EDCA counter is still running, the STA may suspend the first EDCA counter and store the value of the first EDCA counter in memory. During the first TWT service period 602, the STA may start a second EDCA counter at time T3 to determine when the STA may attempt to access the wireless communication medium. If the TWT service period ends (time T4) while the second EDCA counter is still running, the STA may suspend the second EDCA counter and store the value of the second EDCA counter in memory. Then, upon commencing operation outside of the TWT service period (e.g., immediately following time T4), the STA may retrieve the stored value of the first EDCA counter and set the first EDCA counter to that value. If the STA subsequently commences operation within a second TWT service period 604 at time T5, the STA may retrieve the stored value of the second EDCA counter and set the second EDCA counter to that value.

Conversely, in other examples, the STA may reset any running counters at each boundary. For example, referring again to FIG. 6, the STA may reset the first EDCA counter at time T2 and reset the second EDCA counter at time T4 in these alternate examples.

Suspension of a counter may be beneficial in some aspects since this preserves the previous contention and, hence, preserves a previously gained priority. However, suspension of a counter involves the use of additional memory to store the count parameters. Conversely, resetting the counters may be beneficial in some aspects because this process is less complex than the counter suspension procedure and uses less memory than the counter suspension procedure.

Similar considerations may apply to a transmission opportunity (TXOP) obtained prior to a TWT service period boundary. For example, a TXOP may be truncated (e.g., the TXOP may be ended) at or before a TWT service period boundary (e.g., so the STA does not continue to transmit after the boundary and thereby prevent other devices from gaining access to the wireless communication medium after the boundary). Referring again to FIG. 6, if a STA gains access to the wireless communication medium at time T3 and the TXOP for the STA (e.g., a TXOP defined by an access point or a STA) is longer than the period of time from time T3 to time T4, the TXOP may be truncated (e.g., so that the TXOP ends at time T4).

In some examples, a STA may unilaterally truncate (end) a TXOP at a TWT service period boundary. For example, upon determining that a TXOP extends beyond a TWT service period boundary, the STA may stop transmitting at the TWT service period boundary even though the TXOP has not ended. In some examples, the STA does not inform the access point that the TXOP has been truncated. However, the access point (or peer STA) may determine on its own that the STA has terminated the TXOP by detecting a lapse in transmission from the STA for a period of time (e.g., an SIFS period).

In some examples, a STA may truncate a TXOP at a TWT service period boundary and send a message to the access point (or peer STA) to inform the access point (or peer STA) that the TXOP has been truncated. For example, the STA may send such an indication via a connection frame number (CFN) or other suitable signaling. Upon receiving the indication, the access point (or peer STA) may elect to use the remainder of the TXOP or contend for the wireless communication medium.

In some examples, the duration of a TXOP may be specified by taking a TWT service period boundary into account. For example, after gaining access to a wireless communication medium, the STA may determine whether it needs to restrict the length of the TXOP (e.g., where the maximum length of the TXOP may be specified by the access point or peer STA) to ensure that the TXOP does not cross a TWT service period boundary.

As mentioned above, a STA and an access point (or peer STA) can negotiate to define an individual TWT schedule. For example, the STA and the access point (or peer STA) may engage in a TWT request and TWT response exchange for a TWT agreement. Conventionally, this individual TWT schedule is known only to the access point (or peer STA) and that STA. Thus, other STAs will not know what other individual TWT schedules the access point (or peer STA) is currently supporting.

The STAs under an access point may follow broadcast TWTs that are advertised by an access point and are, therefore, known by all of the STAs. Here, the STAs need not tell the access point which TWT schedule they are following. Also, a STA can request creation of additional TWT schedules that satisfy the traffic patterns of the STA. One TWT request may contain several independent TWT schedules. Thus, a STA can join an existing TWT schedule (e.g., that schedules access in a manner that is similar to the STA's traffic patterns) or request additional schedules (e.g., new traffic patterns).

The disclosure relates in some aspects to informing STAs of the usage (e.g., load) associated with individual TWT schedules. A STA could gather statistics on its own by listening in to each TWT schedule. However, these monitoring operations may consume considerable power (e.g., thereby reducing the battery life of the STA) and may take a considerable amount of time to perform.

The disclosure relates in some aspects to the access point (or peer STA) informing STAs of the usage (e.g., load) associated with individual TWT schedules. For example, an access point may transmit information that indicates each TWT schedule (e.g., the parameters of each TWT schedule) and information that indicates usage of each TWT schedule.

In some examples, an access point may transmit a broadcast management frame that that includes this TWT schedule information. A broadcast management frame may include, for example, a beacon (e.g., that includes a defined information pattern), a traffic indication map (TIM) broadcast frame, a fast initial link setup (FILS) discovery frame, or an opportunistic power save (OPS) frame.

In some examples, an access point (or peer STA) may include the TWT schedule information in the same frames (e.g., beacon frames) in which the access point (or peer STA) transmits a broadcast TWT information element (IE). This IE may contain a list of broadcast TWT schedules.

In a first example implementation, an access point may provide (e.g., via a beacon) information about individual TWT schedules (e.g., the schedules of negotiated TWTs as opposed to non-negotiated TWTs such as broadcast TWTs). In this way, the STAs may discover the existence of the individual TWT schedules (e.g., as well as the broadcast TWT schedules). In some examples, the beacon may include at least one individual TWT IE (e.g., one IE for all individual TWT schedules or different IEs for different individual TWT schedules). In some examples, existing TWT IE functionality may be expanded so that both negotiated (e.g., individual) TWT schedules and non-negotiated (e.g., broadcast) TWT schedules are carried in the same IE. In some examples, a new IE (e.g., a TWT Statistics IE) may be defined for carrying the individual TWT schedules.

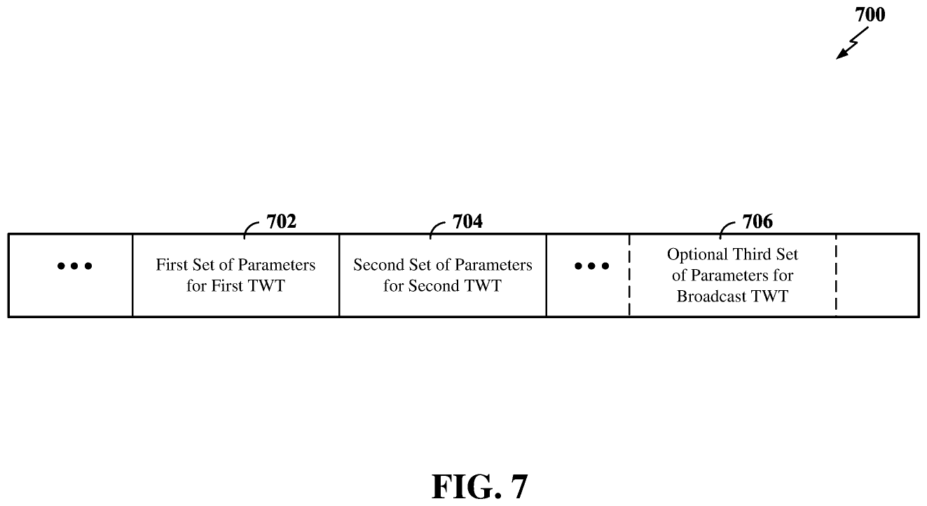

FIG. 7 illustrates an example of an IE 700 (e.g., for a beacon) that includes a first set of parameters for a first TWT 702 and a second set of parameters for a second TWT 704. The IE 700 also may include a third set of parameters for a broadcast TWT 706. The IE 700 may include other sets of parameters for other TWTs as well (not shown).

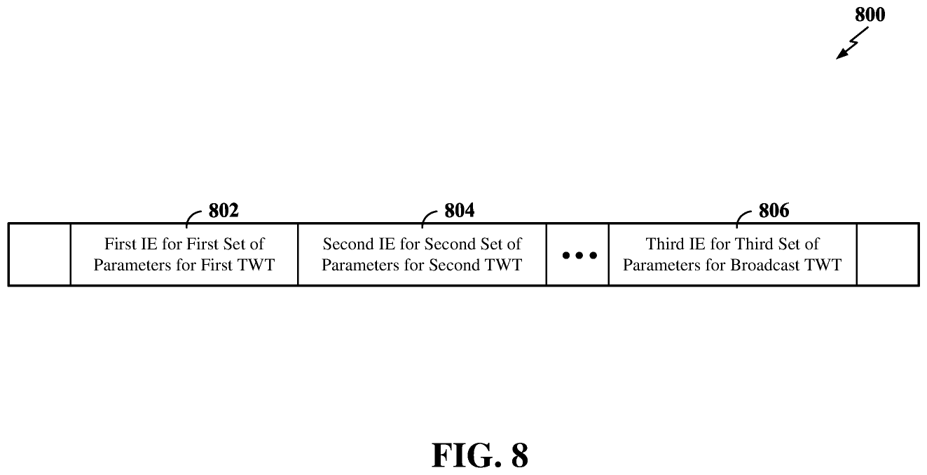

FIG. 8 illustrates an example of a beacon 800 that includes a first IE for a first set of parameters for a first TWT 802 and a second IE for a second set of parameters for a second TWT 804. The beacon 800 also may include a third IE for a third set of parameters for a broadcast TWT 806. The beacon 800 may include other IEs for other sets of parameters for other TWTs as well (not shown).

In a second example implementation, each TWT parameter set may include one or more of the following usage information parameters that follow and/or other parameters indicative of use of a TWT schedule. The second example implementation may be combined with the first example implementation in some examples.

In some examples, a TWT parameter set may indicate the number of STAs being served by the access point in a TWT schedule. For example, a first parameter set for a first TWT schedule may indicate that “X” number of STAs have elected to use the first TWT schedule, a second parameter set for a second TWT schedule may indicate that “Y” number of STAs have elected to use the second TWT schedule, and so on.

In some examples, a TWT parameter set may indicate the type of traffic being sent according to the TWT schedule. A traffic type may indicate, for example, whether the traffic is uplink (UL) traffic, downlink (DL) traffic, both UL and DL traffic, flow traffic, triggered traffic, time sensitive traffic, high priority traffic, low priority traffic, periodic traffic, intermittent traffic, wideband traffic, narrowband traffic, high data rate traffic, low data rate traffic, some other type of traffic, or any suitable combination of the above.

In some examples, a TWT parameter set may indicate the percentage of resources being used (e.g., for each type of traffic). The percentage of resources used may be specified in terms of time, frequency, space, or any combination thereof. For example, a first parameter set for a first TWT schedule may indicate that “X” percent of the TWT service period of the first TWT schedule is being used, a second parameter set for a second TWT schedule may indicate that “Y” percent of the frequency bands allocated for the second TWT schedule is being used, a third parameter set for a third TWT schedule may indicate that “X” percent of the spatial domains allocated for the third TWT schedule is being used, and so on.

In some examples, a TWT parameter set may indicate the percentage of time that the access point is able to access a wireless communication medium of a TWT schedule within a defined time limit (e.g., within a time limit from the TWT service period start time). For example, this usage information may indicate whether the access point is generally able to frequently (or quickly) gain access to the wireless communication medium or whether the access point is rarely able to gain access (or rarely able to quickly gain access) to the wireless communication medium.

The usage information described above may be characterized relative to time. For example, a TWT parameter set may indicate the average number of STAs being served by the access point in each TWT schedule over a period of time, the average percentage of resources being used over a period of time, the average time it takes to access a wireless communication medium of a TWT schedule over a period of time, and so on. The usage information described herein may also be characterized as a variance.

The usage information described herein may be characterized relative to one or more thresholds. For example, a TWT parameter set may indicate the percentage of times that the number of STAs being served by the access point in each TWT schedule exceeds (and/or falls below) a threshold number over a period of time, the percentage of times that the number of resources being used exceeds (and/or falls below) a threshold number over a period of time, the percentage of times that the time it takes to access a wireless communication medium of a TWT schedule exceeds (and/or falls below) a threshold over a period of time, and so on.

The teachings herein may be applicable to communication schedules (e.g., negotiated communication schedules) generally, in addition to TWT schedules. In some aspects, the use of TWT-based scheduling may facilitate adoption into 802.11-based devices (e.g., Wi-Fi devices) since TWT is already supported by and well adopted in, for example, 802.11ax.

An access point may require that all of the STAs operating under (e.g., associated with) the access point use TWT. Thus, a BSS may be defined that supports 802.11 legacy operations and 802.11 extremely high throughput (EHT) operations. Such a BSS may support both 802.11 high efficiency (HE) STAs (TWT plus MU EDCA provides scheduling functionality) and 802.11 EHT STAs (TWT enhancements provides more scheduling functionality).

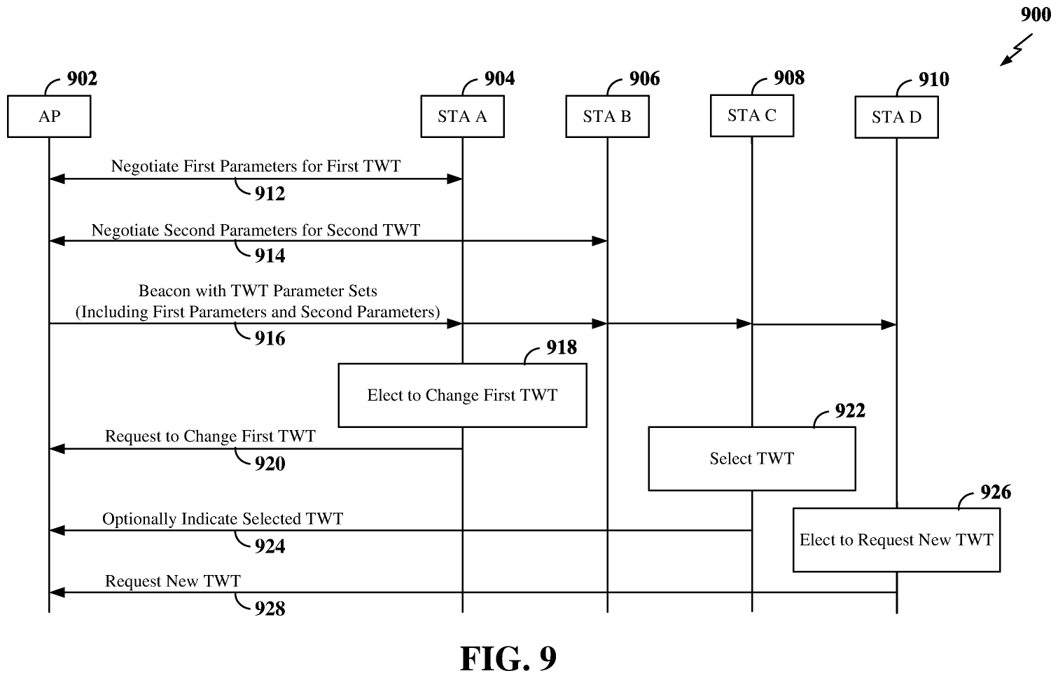

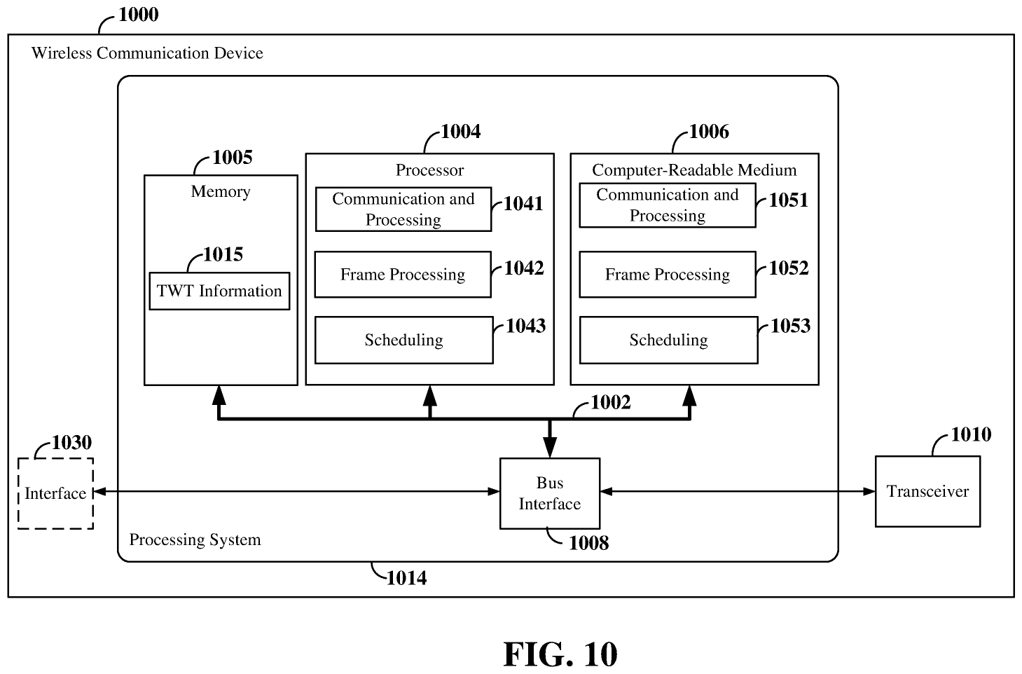

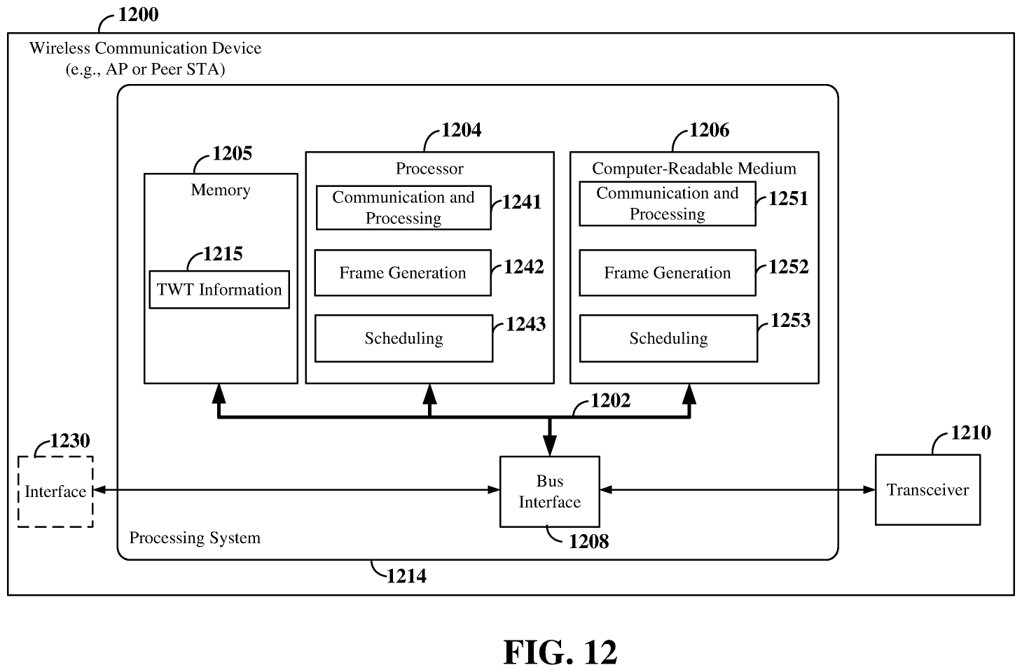

FIG. 9 illustrates an example of TWT parameter signaling 900 in a wireless communication network including an AP 902, a STA A 904, a STA B 906, a STA C 908, and a STA D 910. In some examples, the AP 902 may correspond to one or more of the AP 104 of FIG. 1, the wireless communication device 202 of FIG. 2, or the wireless communication device 1000 of FIG. 12. In some examples, the STA A 904, the STA B 906, the STA C 908, or the STA D 910 may correspond to one or more of the STAs 106 of FIG. 1, the wireless communication device 202 of FIG. 2, or the wireless communication device 1000 of FIG. 10. In some examples, one of more of the AP operations that follow may be performed by a peer STA.

At 912 of FIG. 9, the AP 902 and the STA A 904 may negotiate to determine the parameters to use for a first TWT schedule. For example, the AP 902 and the STA A 904 may select a start time of the first service period for the first TWT schedule, a duration of each service period for the first TWT schedule, a periodicity of the service periods, and other parameters, if applicable.

At 914, the AP 902 and the STA B 906 may negotiate to determine the parameters to use for a second TWT schedule. For example, the AP 902 and the STA B 906 may select a start time of the first service period for the second TWT schedule, a duration of each service period for the second TWT schedule, a periodicity of the service periods, and other parameters, if applicable.

At 916, the AP 902 transmits a beacon that includes the parameter sets for each of the TWT schedules. For example, the beacon may include a first set of parameters for the first TWT schedule and a second set of parameters for the second TWT schedule. As discussed herein, each parameter set may include usage information and other information for a corresponding TWT schedule.

At 918, the STA A 904 elects to change one or more parameters of the first TWT schedule. For example, the STA A 904 may determine, based on usage information for the first TWT schedule that the STA A 904 received at 916, that the STA A 904 would be better served if there was a change in the service period (or some other resource of the first TWT schedule). Thus, at 920, the STA A 904 transmits a request to the AP 902 to change the first TWT schedule.

At 922, the STA C 908 elects to use one of the TWT schedules advertised by the AP 902. For example, the STA C 908 may determine, based on the first TWT schedule and/or the second TWT schedule (and, optionally, corresponding usage information) that the STA C 908 received at 916, that the second TWT schedule is a good fit for the traffic pattern of the STA C 908. The STA C 908 may or may not inform the AP 902 of the selection at 922. In scenarios where the STA C 908 does inform the AP 902 of this selection, at 924, the STA C 908 transmits a message to the AP 902 to indicate the selection of one of the TWT schedules advertised by the AP 902.

At 926, the STA D 910 elects to request a new TWT schedule from the AP 902. For example, the STA D 910 may determine, based on the first TWT schedule and the second TWT schedule (and, optionally, usage information) that the STA D 910 received at 916, that neither of these TWT schedules is a good fit for the traffic pattern of the STA D 910. Thus, at 928, the STA D 910 transmits a request to the AP 902 to create a new TWT schedule.

FIG. 10 is a block diagram illustrating an example of a hardware implementation for a wireless communication device 1000 employing a processing system 1014. For example, the wireless communication device 1000 may be a station (STA) or other device configured to wirelessly communicate with another device (e.g., an access point or a peer STA), as discussed in any one or more of FIGS. 1-9. In some implementations, the wireless communication device 1000 may correspond to one or more of the STAs 106 of FIG. 1, the wireless communication device 202 of FIG. 2, or the STA A 904, the STA B 906, the STA C 908, or the STA D 910 of FIG. 9.

In accordance with various aspects of the disclosure, an element, or any portion of an element, or any combination of elements may be implemented with the processing system 1014 (e.g., that includes one or more processors 1004). Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1000 may be configured to perform any one or more of the functions described herein. That is, the processor 1004, as utilized in a wireless communication device 1000, may be used to implement any one or more of the processes and procedures described below.

The processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010 and between the bus 1002 and an interface 1030. The transceiver 1010 provides a communication interface or means for communicating with various other apparatus over a wireless transmission medium. The interface 1030 provides a communication interface or means of communicating with various other apparatuses and devices (e.g., other devices housed within the same apparatus as the wireless communication device 1000 or other external apparatuses) over an internal bus or external transmission medium, such as an Ethernet cable. Depending upon the nature of the apparatus, the interface 1030 may include a user interface (e.g., keypad, display, speaker, microphone, joystick). Of course, such a user interface is optional, and may be omitted in some examples, such as an IoT device.

The processor 1004 is responsible for managing the bus 1002 and general processing, including the execution of software stored on the computer-readable medium 1006. The software, when executed by the processor 1004, causes the processing system 1014 to perform the various functions described below for any particular apparatus. The computer-readable medium 1006 and the memory 1005 may also be used for storing data that is manipulated by the processor 1004 when executing software. For example, the memory 1005 may store TWT information 1015 used by the processor 1004 for communication operations as described herein.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

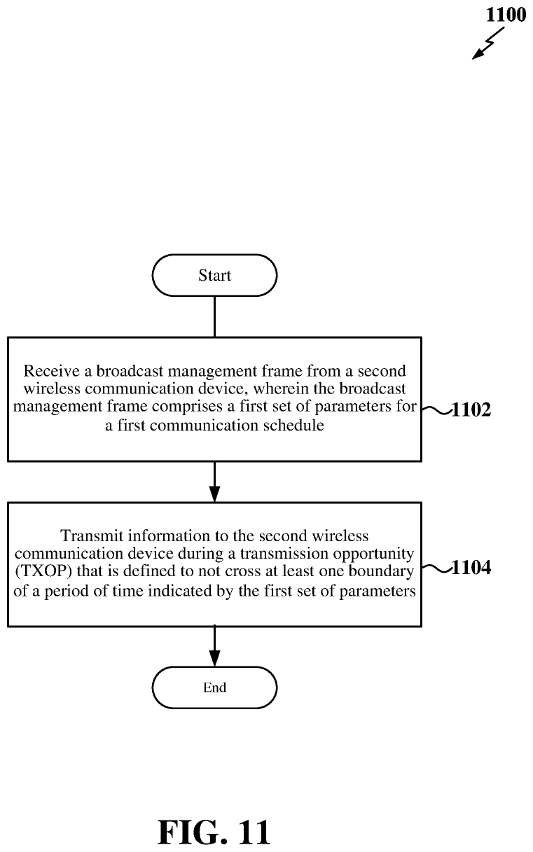

The wireless communication device 1000 may be configured to perform any one or more of the operations described herein (e.g., as described above in conjunction with FIGS. 1-9 and as described below in conjunction with FIG. 11). In some aspects of the disclosure, the processor 1004, as utilized in the wireless communication device 1000, may include circuitry configured for various functions.

The processor 1004 may include communication and processing circuitry 1041. The communication and processing circuitry 1041 may include one or more hardware components that provide the physical structure that performs various processes related to wireless communication (e.g., signal reception and/or signal transmission) as described herein. The communication and processing circuitry 1041 may further include one or more hardware components that provide the physical structure that performs various processes related to signal processing (e.g., processing a received signal and/or processing a signal for transmission) as described herein. In some examples, the communication and processing circuitry 1041 may include two or more transmit/receive chains, each configured to process signals in a different RAT (or RAN) type. The communication and processing circuitry 1041 may further be configured to execute communication and processing software 1051 included on the computer-readable medium 1006 to implement one or more functions described herein.

In some implementations where the communication involves receiving information, the communication and processing circuitry 1041 may obtain information from a component of the wireless communication device 1000 (e.g., from the transceiver 1010 that receives the information via radio frequency signaling or some other type of signaling suitable for the applicable communication medium), process (e.g., decode) the information, and output the processed information. For example, the communication and processing circuitry 1041 may output the information to another component of the processor 1004, to the memory 1005, or to the bus interface 1008. In some examples, the communication and processing circuitry 1041 may receive one or more of signals, messages, other information, or any combination thereof. In some examples, the communication and processing circuitry 1041 may receive information via one or more channels. In some examples, the communication and processing circuitry 1041 may include functionality for a means for receiving. In some examples, the communication and processing circuitry 1041 may include functionality for a means for decoding.

In some implementations where the communication involves sending (e.g., transmitting) information, the communication and processing circuitry 1041 may obtain information (e.g., from another component of the processor 1004, the memory 1005, or the bus interface 1008), process (e.g., encode) the information, and output the processed information. For example, the communication and processing circuitry 1041 may output the information to the transceiver 1010 (e.g., that transmits the information via radio frequency signaling or some other type of signaling suitable for the applicable communication medium). In some examples, the communication and processing circuitry 1041 may send one or more of signals, messages, other information, or any combination thereof. In some examples, the communication and processing circuitry 1041 may send information via one or more channels. In some examples, the communication and processing circuitry 1041 may include functionality for a means for sending (e.g., means for transmitting). In some examples, the communication and processing circuitry 1041 may include functionality for a means for encoding.

The processor 1004 may include frame processing circuitry 1042 configured to perform frame processing-related operations as discussed herein. The frame processing circuitry 1042 may be configured to execute frame processing software 1052 included on the computer-readable medium 1006 to implement one or more functions described herein.

The frame processing circuitry 1042 may include functionality for a means for receiving a broadcast management frame. For example, the frame processing circuitry 1042 may be configured to receive a beacon frame and parse information (e.g., TWT schedule parameters) contained in the beacon frame.

The processor 1004 may include scheduling circuitry 1043 configured to perform scheduling-related operations as discussed herein. The scheduling circuitry 1043 may be configured to execute scheduling software 1053 included on the computer-readable medium 1006 to implement one or more functions described herein.

The scheduling circuitry 1043 may include functionality for a means for identifying a period of time for communication with an access point. For example, the scheduling circuitry 1043 may be configured to determine whether a particular TWT schedule is a good fit for the traffic pattern of the wireless communication device. As another example, the scheduling circuitry 1043 may be configured to determine that the parameters of a TWT schedule should be changed to better fit the traffic pattern of the wireless communication device. As a further example, the scheduling circuitry 1043 may be configured to elect to request a new TWT schedule better fits the traffic pattern of the first wireless communication device.

The scheduling circuitry 1043 may include functionality for a means for transmitting information during a TXOP. For example, the scheduling circuitry 1043 may be configured to cause information to be transmitted during the TXOP until a boundary of a service period is reached. Once the boundary is reached, the scheduling circuitry 1043 may be configured to end the transmission of the information.

The scheduling circuitry 1043 may include functionality for a means for defining or truncating a TXOP. For example, the scheduling circuitry 1043 may be configured to determine that the TXOP extends beyond at least one boundary of a service period defined by a TWT schedule. As another example, the scheduling circuitry 1043 may be configured to end a TXOP at or before at least one boundary of a service period defined by a TWT schedule.

The scheduling circuitry 1043 may include functionality for a means for suspending, resuming, or resetting a counter. For example, the scheduling circuitry 1043 may be configured to suspend a first counter at a first service period boundary, and start or resume a second counter at the first service boundary. As another example, the scheduling circuitry 1043 may be configured to resume the first counter at a second service period boundary, and suspend the second counter at the second service boundary.

FIG. 11 is a flow chart illustrating an example wireless communication process 1100 in accordance with some aspects of the present disclosure. As described below, some or all illustrated features may be omitted in a particular implementation within the scope of the present disclosure, and some illustrated features may not be required for implementation of all examples. In some examples, the process 1100 may be carried out by the wireless communication device 1000 illustrated in FIG. 10. In some examples, the process 1100 may be performed by a STA (e.g., a user equipment). In some examples, the process 1100 may be carried out by any suitable apparatus or means for carrying out the functions or algorithm described below.

At block 1102, a first wireless communication device may receive a broadcast management frame from a second wireless communication device, wherein the broadcast management frame comprises a first set of parameters for a first communication schedule. For example, the frame processing circuitry 1042 in cooperation with the communication and processing circuitry 1041 and the transceiver 1010, shown and described above in connection with FIG. 10, may provide a means to receive a broadcast management frame from a second wireless communication device.

In some examples, the first communication schedule is a negotiated communication schedule. In some examples, the first communication schedule is a non-negotiated communication schedule.

In some examples, the first communication schedule may include a target wake time (TWT) schedule. In some examples, the first communication schedule may specify, for a service period, at least one of a start time of the service period, a duration of the service period, a periodicity of the service period, or any combination thereof.

In some examples, the first set of parameters for the first communication schedule may specify, for at least one service period, at least one of a quantity of stations scheduled to be served by the second wireless communication device during the at least one service period, at least one type of traffic scheduled during the at least one service period, a percentage of resources scheduled during the at least one service period, a percentage of time that resources are scheduled during the at least one service period, access time information associated with the at least one service period, at least one variance associated with use of the at least one service period over time, at least one average associated with use of the at least one service period over time, or any combination thereof.

In some examples, the broadcast management frame may include (e.g., may be) a beacon, a traffic indication map (TIM) broadcast frame, a fast initial link setup (FILS) discovery frame, or an opportunistic power save (OPS) frame.

In some examples, the broadcast management frame may include a first information element (IE) that includes the first set of parameters for the first communication schedule and a second set of parameters for a second communication schedule. In some examples, the broadcast management frame may further include a third IE that includes a third set of parameters for a broadcast communication schedule.

At block 1104, the first wireless communication device may transmit information to the second wireless communication device during a transmission opportunity (TXOP) that is defined to not cross at least one boundary of a period of time indicated by the first set of parameters. For example, the scheduling circuitry 1043 in cooperation with the communication and processing circuitry 1041 and the transceiver 1010, shown and described above in connection with FIG. 10, may provide a means to transmit information to the second wireless communication device during a transmission opportunity (TXOP) that is defined to not cross at least one boundary of a period of time indicated by the first set of parameters.

In some examples, the first wireless communication device may elect to use the first communication schedule for a communication with the second wireless communication device. In some examples, the first wireless communication device may send a request to the second wireless communication device to create a second communication schedule for the communication with the second wireless communication device. In some examples, the first wireless communication device may send a request to the second wireless communication device to modify the first communication schedule or a second communication schedule.

In some examples, the broadcast management frame may further include a second set of parameters for a second communication schedule. In this case, the first wireless communication device may select the second communication schedule for a communication with the second wireless communication device based on the first set of parameters for the first communication schedule and the second set of parameters for the second communication schedule.

In some examples, the first set of parameters defines a service period. In this case, the first wireless communication device may determine a time to transmit during the service period, determine a frequency resource to use during the service period, determine a spatial resource to use during the service period, or any combination thereof.

In some examples, the broadcast management frame may include an information element (IE) that includes the first set of parameters for the first communication schedule. In some examples, the IE may further include a second set of parameters for a second communication schedule. In some examples, the IE may further include a third set of parameters for a broadcast communication schedule. In some examples, the first wireless communication device may select the period of time based on the third set of parameters for the broadcast communication schedule.

In some examples, the first wireless communication device may define the TXOP based on the at least one boundary. In some examples, the first wireless communication device may truncate the TXOP based on the at least one boundary. In some examples, the first wireless communication device may transmit a message to the second wireless communication device to indicate that the TXOP has been truncated. In some examples, the first wireless communication device may receive, from the second wireless communication device, an indication that the TXOP has been truncated based on the at least one boundary.

In some examples, the first wireless communication device may suspend a first medium access counter (e.g., a wireless communication medium access counter or timer) at the at least one boundary. In some examples, the first wireless communication device may resume a second medium access counter at the at least one boundary. In some examples, the first wireless communication device may reset a medium access counter at the at least one boundary.

In one configuration, the wireless communication device 1000 includes means for receiving a broadcast management frame from a second wireless communication device, wherein the broadcast management frame comprises a first set of parameters for a first communication schedule, and means for means for transmitting information to the second wireless communication device during a transmission opportunity (TXOP) that is defined to not cross at least one boundary of a period of time indicated by the first set of parameters. In one aspect, the aforementioned means may be the processor 1004 shown in FIG. 10 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable medium 1006, or any other suitable apparatus or means described in any one or more of FIGS. 1, 2, 9, and 10, and utilizing, for example, the methods and/or algorithms described herein in relation to FIG. 11.

FIG. 12 is a conceptual diagram illustrating an example of a hardware implementation for a wireless communication device 1200 employing a processing system 1214. In some implementations, the wireless communication device 1200 (e.g., an AP) may correspond to may correspond to one or more of the AP 104 of FIG. 1, the wireless communication device 202 of FIG. 2, or the AP 902 of FIG. 9. In some implementations, the wireless communication device 1200 (e.g., a peer STA) may correspond to one or more of the STAs 106 of FIG. 1, the wireless communication device 202 of FIG. 2, or the STA A 904, the STA B 906, the STA C 908, or the STA D 910 of FIG. 9.

In accordance with various aspects of the disclosure, an element, or any portion of an element, or any combination of elements may be implemented with the processing system 1214 (e.g., that includes one or more processors 1204). The processing system 1214 may be substantially the same as the processing system 1014 illustrated in FIG. 10, including a bus interface 1208, a bus 1202, memory 1205, a processor 1204, and a computer-readable medium 1206. Furthermore, the wireless communication device 1200 may include an interface 1230 (e.g., a network interface) that provides a means for communicating with at least one other apparatus within at least one radio network. The memory 1205 may store TWT information 1215 used by the processor 1204 for communication operations as described herein.

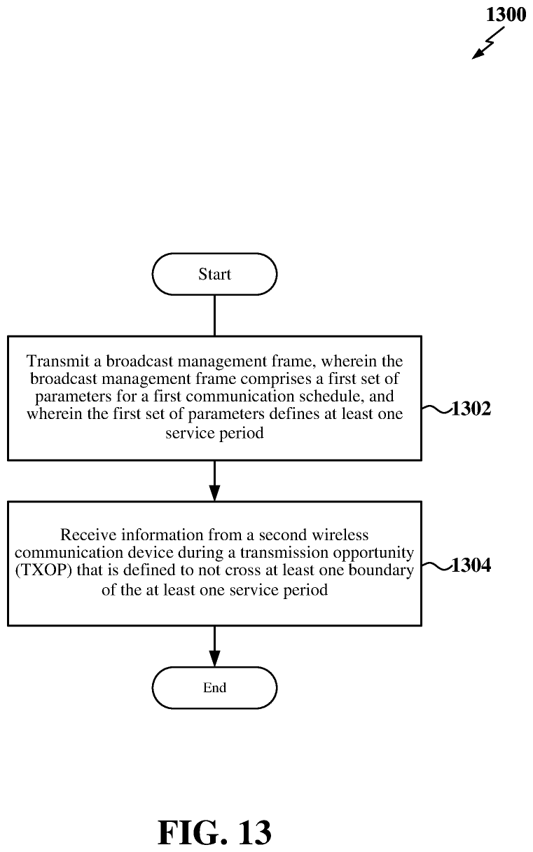

The wireless communication device 1200 may be configured to perform any one or more of the operations described herein (e.g., as described above in conjunction with FIGS. 1-9 and as described below in conjunction with FIG. 13). In some aspects of the disclosure, the processor 1204, as utilized in the wireless communication device 1200, may include circuitry configured for various functions.

In some aspects of the disclosure, the processor 1204 may include communication and processing circuitry 1241. The communication and processing circuitry 1241 may include one or more hardware components that provide the physical structure that performs various processes related to communication (e.g., signal reception and/or signal transmission) as described herein. The communication and processing circuitry 1241 may further include one or more hardware components that provide the physical structure that performs various processes related to signal processing (e.g., processing a received signal and/or processing a signal for transmission) as described herein. The communication and processing circuitry 1241 may further be configured to execute communication and processing software 1251 included on the computer-readable medium 1206 to implement one or more functions described herein.

In some implementations where the communication involves receiving information, the communication and processing circuitry 1241 may obtain information from a component of the wireless communication device 1200 (e.g., from the transceiver 1210 that receives the information via radio frequency signaling or some other type of signaling suitable for the applicable communication medium), process (e.g., decode) the information, and output the processed information. For example, the communication and processing circuitry 1241 may output the information to another component of the processor 1204, to the memory 1205, or to the bus interface 1208. In some examples, the communication and processing circuitry 1241 may receive one or more of signals, messages, other information, or any combination thereof. In some examples, the communication and processing circuitry 1241 may receive information via one or more channels. In some examples, the communication and processing circuitry 1241 may include functionality for a means for receiving. In some examples, the communication and processing circuitry 1241 may include functionality for a means for decoding.

In some implementations where the communication involves sending (e.g., transmitting) information, the communication and processing circuitry 1241 may obtain information (e.g., from another component of the processor 1204, the memory 1205, or the bus interface 1208), process (e.g., encode) the information, and output the processed information. For example, the communication and processing circuitry 1241 may output the information to the transceiver 1210 (e.g., that transmits the information via radio frequency signaling or some other type of signaling suitable for the applicable communication medium). In some examples, the communication and processing circuitry 1241 may send one or more of signals, messages, other information, or any combination thereof. In some examples, the communication and processing circuitry 1241 may send information via one or more channels. In some examples, the communication and processing circuitry 1241 may include functionality for a means for sending (e.g., means for transmitting). In some examples, the communication and processing circuitry 1241 may include functionality for a means for encoding.

The processor 1204 may include frame generation circuitry 1242 configured to perform frame generation-related operations as discussed herein. The frame generation circuitry 1242 may be configured to execute frame generation software 1252 included on the computer-readable medium 1206 to implement one or more functions described herein.

The frame generation circuitry 1242 may include functionality for a means for transmitting a frame. For example, the frame generation circuitry 1242 may be configured to generate a broadcast management frame (e.g., a beacon frame) that includes at least one parameter for a TWT schedule. As another example, the frame generation circuitry 1242 may be configured to transmit (e.g., broadcast) the frame to any STAs in communication with (e.g., served by) the wireless communication device 1200.

The frame generation circuitry 1242 may include functionality for a means for identifying packet filter information. For example, the frame generation circuitry 1242 may be configured to identify information to be included in a packet.

The processor 1204 may include scheduling circuitry 1243 configured to perform scheduling-related operations as discussed herein. The scheduling circuitry 1243 may be configured to execute scheduling software 1253 included on the computer-readable medium 1206 to implement one or more functions described herein.

The scheduling circuitry 1243 may include functionality for a means for defining a TXOP. For example, the scheduling circuitry 1243 may be configured to define a TXOP so that the TXOP does not extend beyond a boundary of a service period.

The scheduling circuitry 1243 may include functionality for a means for determining that a wireless communication device has truncated a TXOP. For example, the scheduling circuitry 1243 may be configured to receive and process a message from a STA indicating that the STA has truncated (e.g., ended) a particular TXOP. As another example, the scheduling circuitry 1243 may be configured to determine that a transmission has not been received from a STA for more than a threshold period of time during a particular TXOP.

The scheduling circuitry 1243 may include functionality for a means for receiving information during a TXOP. For example, the scheduling circuitry 1243 may be configured to receive a data transmission according to a TWT schedule advertised by the wireless communication device 1200. As another example, the scheduling circuitry 1243 may be configured to cause information to be received during the TXOP until a boundary of a service period is reached. Once the boundary is reached, the scheduling circuitry 1243 may be configured to end the reception of the information.

The scheduling circuitry 1243 may include functionality for a means for determining a set of parameters for a communication schedule. For example, the scheduling circuitry 1243 may be configured to negotiate with a wireless communication device (e.g., a STA) to determine the parameters (e.g., service period start time, service period duration, etc.) for a TWT schedule.

FIG. 13 is a flow chart illustrating an example wireless communication process 1300 in accordance with some aspects of the present disclosure. As described below, some or all illustrated features may be omitted in a particular implementation within the scope of the present disclosure, and some illustrated features may not be required for implementation of all examples. In some examples, the process 1300 may be carried out by the wireless communication device 1200 illustrated in FIG. 12. In some examples, the wireless communication process 1300 may be performed by an access point. In some examples, the process 1300 may be carried out by any suitable apparatus or means for carrying out the functions or algorithm described below.

At block 1302, a first wireless communication device may transmit a broadcast management frame, wherein the broadcast management frame comprises a first set of parameters for a first communication schedule, and wherein the first set of parameters defines at least one service period. For example, the frame generation circuitry 1242 in cooperation with the communication and processing circuitry 1241 and the transceiver 1210, shown and described above in connection with FIG. 12, may provide a means to transmit a broadcast management frame.

In some examples, the first communication schedule is a negotiated communication schedule. In some examples, the first communication schedule is a non-negotiated communication schedule.

In some examples, the first communication schedule may include a target wake time (TWT) schedule. In some examples, the first communication schedule may specify, for a service period, at least one of a start time of the service period, a duration of the service period, a periodicity of the service period, or any combination thereof.

In some examples, the first set of parameters for the first communication schedule may specify, for at least one service period, at least one of a quantity of stations scheduled to be served by the first wireless communication device during the at least one service period, at least one type of traffic scheduled during the at least one service period, a percentage of resources scheduled during the at least one service period, a percentage of time that resources are scheduled during the at least one service period, access time information associated with the at least one service period, at least one variance associated with use of the at least one service period over time, at least one average associated with use of the at least one service period over time, or any combination thereof.

In some examples, the first wireless communication device may negotiate with the second wireless communication device or a third wireless communication device to select the first set of parameters for the first communication schedule. In some examples, the first wireless communication device may receive a request to create the first communication schedule. In some examples, the first wireless communication device may receive a request to modify the first communication schedule.

At block 1304, the first wireless communication device may receive information from a second wireless communication device during a transmission opportunity (TXOP) that is defined to not cross at least one boundary of the at least one service period. For example, the scheduling circuitry 1243 in cooperation with the communication and processing circuitry 1241 and the transceiver 1210, shown and described above in connection with FIG. 12, may provide a means to receive information from a second wireless communication device during a transmission opportunity (TXOP) that is defined to not cross at least one boundary of the service period.

In some examples, the broadcast management frame may include (e.g., may be) a beacon, a traffic indication map (TIM) broadcast frame, a fast initial link setup (FILS) discovery frame, or an opportunistic power save (OPS) frame. In some examples, the broadcast management frame may include an information element (IE) that includes the first set of parameters for the first communication schedule. In some examples, the IE may further include a second set of parameters for a second communication schedule. In some examples, the process may further include defining a third set of parameters for a broadcast communication schedule. In this case, the IE may further include the third set of parameters for the broadcast communication schedule.

In some examples, the broadcast management frame may include a first information element (IE) that includes the first set of parameters for the first communication schedule. In some examples, the broadcast management frame may include a second set of parameters for a second communication schedule. In some examples, the broadcast management frame may further include a third IE that includes a third set of parameters for a broadcast communication schedule.

In some examples, the first wireless communication device may determine a second set of parameters for a second communication schedule. In this case, the broadcast management frame may further include the second set of parameters for the second communication schedule.

In some examples, the first wireless communication device may receive a signal from the first wireless communication device and determine, based on the signal, that the first wireless communication device truncated a transmission opportunity (TXOP) based on a boundary associated with the first communication schedule. In some examples, the signal may include a message from the first wireless communication device indicating that the first wireless communication device truncated the TXOP. In some examples, the signal may be received during the TXOP (e.g., the first wireless communication device may determine that a signal ceased at a TWT service period boundary).

In some examples, the first wireless communication device may define the TXOP based on the at least one boundary. In this case, the process may further include transmitting an indication that the TXOP has been truncated.

In one configuration, the wireless communication device 1200 includes means for transmitting a broadcast management frame, wherein the broadcast management frame comprises a first set of parameters for a first communication schedule, and wherein the first set of parameters defines at least one service period, and means for receiving information from a second wireless communication device during a transmission opportunity (TXOP) that is defined to not cross at least one boundary of the at least one service period. In one aspect, the aforementioned means may be the processor 1204 shown in FIG. 12 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable medium 1206, or any other suitable apparatus or means described in any one or more of FIGS. 1, 2, 9, and 12, and utilizing, for example, the methods and/or algorithms described herein in relation to FIG. 13.

The methods shown in FIGS. 11 and 13 may include additional aspects, such as any single aspect or any combination of aspects described below and/or in connection with one or more other processes described elsewhere herein. The following provides an overview of several aspects of the present disclosure.
Aspect 1: A method for wireless communication at a first wireless communication device, the method comprising: receiving a broadcast management frame from a second wireless communication device, wherein the broadcast management frame comprises a first set of parameters for a first communication schedule; and transmitting information to the second wireless communication device during a transmission opportunity (TXOP) that is defined to not cross at least one boundary of a period of time indicated by the first set of parameters.
Aspect 2: The method of aspect 1, wherein the first communication schedule comprises a target wake time (TWT) schedule.
Aspect 3: The method of aspect 1 or 2, wherein the first communication schedule specifies, for a service period, at least one of: a start time of the service period, a duration of the service period, a periodicity of the service period, or any combination thereof.
Aspect 4: The method of any of aspects 1 through 3, wherein the first set of parameters for the first communication schedule specifies, for at least one service period, at least one of: a quantity of stations scheduled to be served by the second wireless communication device during the at least one service period, at least one type of traffic scheduled during the at least one service period, a percentage of resources scheduled during the at least one service period, a percentage of time that resources are scheduled during the at least one service period, access time information associated with the at least one service period, at least one variance associated with use of the at least one service period over time, at least one average associated with use of the at least one service period over time, or any combination thereof.
Aspect 5: The method of any of aspects 1 through 4, wherein the broadcast management frame comprises a beacon, a traffic indication map (TIM) broadcast frame, a fast initial link setup (FILS) discovery frame, or an opportunistic power save (OPS) frame.
Aspect 6: The method of any of aspects 1 through 5, further comprising electing to use the first communication schedule for a communication with the second wireless communication device.
Aspect 7: The method of any of aspects 1 through 6, wherein: the broadcast management frame further comprises a second set of parameters for a second communication schedule; and further comprises selecting the second communication schedule for a communication with the second wireless communication device based on the first set of parameters for the first communication schedule and the second set of parameters for the second communication schedule.
Aspect 8: The method of any of aspects 1 through 7, further comprising sending a request to the second wireless communication device to create a second communication schedule for a communication with the second wireless communication device.
Aspect 9: The method of any of aspects 1 through 7, further comprising sending a request to the second wireless communication device to modify the first communication schedule or a second communication schedule.
Aspect 10: The method of any of aspects 1 through 9, wherein: the first set of parameters defines a service period; and the method further comprises at least one of: determining a time to transmit during the service period, determining a frequency resource to use during the service period, determining a spatial resource to use during the service period, or any combination thereof.
Aspect 11: The method of any of aspects 1 through 10, further comprising defining the TXOP based on the at least one boundary.
Aspect 12: The method of any of aspects 1 through 10, further comprising truncating the TXOP based on the at least one boundary.
Aspect 13: The method of aspect 12, further comprising transmitting a message to the second wireless communication device to indicate that the TXOP has been truncated.
Aspect 14: The method of any of aspects 1 through 11, further comprising receiving, from the second wireless communication device, an indication that the TXOP has been truncated based on the at least one boundary.
Aspect 15: The method of any of aspects 1 through 14, further comprising suspending a first medium access counter at the at least one boundary.
Aspect 16: The method of aspect 15, further comprising resuming a second medium access counter at the at least one boundary.
Aspect 17: The method of any of aspects 1 through 14, resetting a medium access counter at the at least one boundary.
Aspect 18: The method of any of aspects 1 through 17, wherein the broadcast management frame comprises an information element (IE) that includes the first set of parameters for the first communication schedule.
Aspect 19: The method of aspect 18, wherein the IE further comprises a second set of parameters for a second communication schedule.
Aspect 20: The method of aspect 19, wherein the IE further comprises a third set of parameters for a broadcast communication schedule.
Aspect 21: The method of any of aspects 1 through 20, further comprising selecting the period of time based on the third set of parameters for the broadcast communication schedule.
Aspect 22: The method of any of aspects 1 through 21, wherein the broadcast management frame comprises: a first information element (IE) that includes the first set of parameters for the first communication schedule; and a second set of parameters for a second communication schedule.
Aspect 23: The method of aspect 22, wherein the broadcast management frame further comprises a third IE that includes a third set of parameters for a broadcast communication schedule.
Aspect 24: A wireless communication device comprising: a transceiver configured to communicate with a radio access network, a memory, and a processor communicatively coupled to the transceiver and the memory, wherein the processor and the memory are configured to perform any one of aspects 1 through 23.
Aspect 25: An apparatus configured for wireless communication comprising at least one means for performing any one of aspects 1 through 23.
Aspect 26: A non-transitory computer-readable medium storing computer-executable code, comprising code for causing an apparatus to perform any one of aspects 1 through 23.
Aspect 27: A method for wireless communication at a first wireless communication device, the method comprising: transmitting a broadcast management frame, wherein the broadcast management frame comprises a first set of parameters for a first communication schedule, and wherein the first set of parameters defines at least one service period; and receiving information from a second wireless communication device during a transmission opportunity (TXOP) that is defined to not cross at least one boundary of the at least one service period.
Aspect 28: The method of aspect 27, wherein the first communication schedule comprises a target wake time (TWT) schedule.
Aspect 29: The method of any of aspects 1 through 28, wherein the first communication schedule specifies, for the at least one service period, at least one of: a start time of the at least one service period, a duration of the at least one service period, a periodicity of the at least one service period, or any combination thereof.
Aspect 30: The method of any of aspects 27 through 29, wherein the first set of parameters for the first communication schedule specifies, for the at least one service period, at least one of: a quantity of stations scheduled to be served by the first wireless communication device during the at least one service period, at least one type of traffic scheduled during the at least one service period, a percentage of resources scheduled during the at least one service period, a percentage of time that resources are scheduled during the at least one service period, access time information associated with the at least one service period, at least one variance associated with use of the at least one service period over time, at least one average associated with use of the at least one service period over time, or any combination thereof.
Aspect 31: The method of any of aspects 27 through 30, wherein the broadcast management frame comprises a beacon, a traffic indication map (TIM) broadcast frame, a fast initial link setup (FILS) discovery frame, or an opportunistic power save (OPS) frame.
Aspect 32: The method of any of aspects 27 through 31, further comprising negotiating with the second wireless communication device or a third wireless communication device to select the first set of parameters for the first communication schedule.
Aspect 33: The method of any of aspects 27 through 32, wherein: the method further comprises determine a second set of parameters for a second communication schedule; and the broadcast management frame further comprises the second set of parameters for the second communication schedule.
Aspect 34: The method of any of aspects 27 through 32, further comprising receiving a request to create the first communication schedule.
Aspect 35: The method of any of aspects 27 through 34, further comprising receiving a request to modify the first communication schedule.
Aspect 36: The method of any of aspects 27 through 35, further comprising: receiving a signal from the second wireless communication device; and determining, based on the signal, that the second wireless communication device truncated the TXOP based on the at least one boundary.
Aspect 37: The method of aspect 36, wherein the signal comprises a message from the second wireless communication device indicating that the second wireless communication device truncated the TXOP.
Aspect 38: The method of any of aspects 36 through 37, wherein the signal is received during the TXOP.
Aspect 39: The method of any of aspects 27 through 35, further comprising: defining the TXOP based on the at least one boundary; and transmitting an indication that the TXOP has been truncated.
Aspect 40: The method of any of aspects 27 through 39, wherein the broadcast management frame comprises an information element (IE) that includes the first set of parameters for the first communication schedule.
Aspect 41: The method of aspect 40, wherein the IE further comprises a second set of parameters for a second communication schedule.
Aspect 42: The method of aspect 41, wherein: the method further comprises defining a third set of parameters for a broadcast communication schedule; and the IE further comprises the third set of parameters for the broadcast communication schedule.
Aspect 43: The method of any of aspects 27 through 42, wherein the broadcast management frame comprises: a first information element (IE) that includes the first set of parameters for the first communication schedule; and a second set of parameters for a second communication schedule.
Aspect 44: The method of aspect 43, wherein the broadcast management frame further comprises a third IE that includes a third set of parameters for a broadcast communication schedule.
Aspect 45: A wireless communication device comprising: a transceiver configured to communicate with a radio access network, a memory, and a processor communicatively coupled to the transceiver and the memory, wherein the processor and the memory are configured to perform any one of aspects 27 through 44.
Aspect 46: An apparatus configured for wireless communication comprising at least one means for performing any one of aspects 27 through 44.
Aspect 47: A non-transitory computer-readable medium storing computer-executable code, comprising code for causing an apparatus to perform any one of aspects 27 through 44.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within systems defined by the IEEE 802.11 (Wi-Fi) standards such as 802.11ax, 802.11be, and so on. Various aspects may also be extended to systems defined by the 3rd Generation Partnership Project (3GPP) such 5G, as Long-Term Evolution (LTE), the Evolved Packet System (EPS), the Universal Mobile Telecommunication System (UMTS), and/or the Global System for Mobile (GSM)CDMA2000 and/or Evolution-Data Optimized (EV-DO). Other examples may be implemented within systems employing IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 4, 9, 10, and 12 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A first wireless communication device, comprising:
a transceiver;
a memory; and
a processor communicatively coupled to the transceiver and the memory, wherein the processor and the memory are configured to:
receive a broadcast management frame from a second wireless communication device via the transceiver, wherein the broadcast management frame comprises a first set of parameters for a first communication schedule; and
transmit information to the second wireless communication device via the transceiver during a transmission opportunity (TXOP) that is defined to not cross at least one boundary of a period of time indicated by the first set of parameters.

2. The first wireless communication device of claim 1, wherein the first communication schedule comprises a target wake time (TWT) schedule associated with a service period restriction.

3. The first wireless communication device of claim 1, wherein the first set of parameters indicates, for a service period, at least one of: a start time of the service period, a duration of the service period, a periodicity of the service period, or any combination thereof.

4. The first wireless communication device of claim 1, wherein the first set of parameters specifies, for at least one service period, at least one type of traffic associated with high priority traffic, time sensitive traffic, or any combination thereof.

5. The first wireless communication device of claim 1, wherein the broadcast management frame comprises a beacon, a traffic indication map (TIM) broadcast frame, a fast initial link setup (FILS) discovery frame, or an opportunistic power save (OPS) frame.

6. (canceled)

7. The first wireless communication device of claim 1, wherein:
the broadcast management frame further comprises a second set of parameters for a second communication schedule; and
the processor and the memory are further configured to select the second communication schedule for a communication with the second wireless communication device based on at least one of the first set of parameters for the first communication schedule or the second set of parameters for the second communication schedule.

8. The first wireless communication device of claim 1, wherein the processor and the memory are further configured to:
send a request to the second wireless communication device to create a second communication schedule for a communication with the second wireless communication device.

9. The first wireless communication device of claim 1, wherein the processor and the memory are further configured to:
send a request to the second wireless communication device to modify the first communication schedule or a second communication schedule.

10. The first wireless communication device of claim 1, wherein:
the first set of parameters defines a service period; and
the processor and the memory are further configured to perform at least one of: determine a time to transmit during the service period, determine a frequency resource to use during the service period, determine a spatial resource to use during the service period, or any combination thereof.

11. The first wireless communication device of claim 1, wherein the processor and the memory are further configured to:
obtain a first TXOP having a duration based on the at least one boundary.

12. The first wireless communication device of claim 1, wherein the processor and the memory are further configured to:
obtain a first TXOP having a duration;
truncate the duration of the first TXOP based on the at least one boundary; and
transmit a message to indicate that the duration of the first TXOP has been truncated.

13. (canceled)

14. The first wireless communication device of claim 1, wherein the processor and the memory are further configured to:
receive, from the second wireless communication device, an indication that the TXOP has been truncated based on the at least one boundary.

15-16. (canceled)

17. The first wireless communication device of claim 1, wherein the processor and the memory are further configured to:
reset a medium access counter at the at least one boundary.

18. The first wireless communication device of claim 1, wherein:
the broadcast management frame comprises an information element (IE) that includes the first set of parameters for the first communication schedule; and
the first communication schedule comprises a target wake time (TWT) schedule associated with a service period restriction.

19. (canceled)

20. The first wireless communication device of claim 18, wherein the IE further comprises a second set of parameters for a communication schedule that is not associated with a service period restriction.

21. The first wireless communication device of claim 20, wherein the processor and the memory are further configured to:
select the period of time based on the second set of parameters for the communication schedule that is not associated with a service period restriction.

22-23. (canceled)

24. A method for wireless communication at a first wireless communication device, the method comprising:
receiving a broadcast management frame from a second wireless communication device, wherein the broadcast management frame comprises a first set of parameters for a first communication schedule; and
transmitting information to the second wireless communication device during a transmission opportunity (TXOP) that is defined to not cross at least one boundary of a period of time indicated by the first set of parameters.

25-26. (canceled)

27. A first wireless communication device, comprising:
a transceiver;
a memory; and
a processor communicatively coupled to the transceiver and the memory, wherein the processor and the memory are configured to:
transmit a broadcast management frame via the transceiver, wherein the broadcast management frame comprises a first set of parameters for a first communication schedule; and
receive information from a second wireless communication device via the transceiver during a transmission opportunity (TXOP) that is defined to not cross at least one boundary of a period of time indicated by the first set of parameters.

28. The first wireless communication device of claim 27, wherein the first communication schedule comprises a target wake time (TWT) schedule associated with a service period restriction.

29. The first wireless communication device of claim 27, wherein the first set of parameters indicates, for the at least one service period, at least one of: a start time of the at least one service period, a duration of the at least one service period, a periodicity of the at least one service period, or any combination thereof.

30. The first wireless communication device of claim 27, wherein the first set of parameters specifies, for at least one service period, at least one type of traffic associated with high priority traffic, time sensitive traffic, or any combination thereof.

31-44. (canceled)

45. A method for wireless communication at a first wireless communication device, the method comprising:
transmitting a broadcast management frame, wherein the broadcast management frame comprises a first set of parameters for a first communication schedule; and
receiving information from a second wireless communication device during a transmission opportunity (TXOP) that is defined to not cross at least one boundary of a period of time indicated by the first set of parameters.

46-47. (canceled)

48. The method of claim 24, wherein the first communication schedule comprises a target wake time (TWT) schedule associated with a service period restriction.

49. The method of claim 24, wherein the first set of parameters indicates, for a service period, at least one of: a start time of the service period, a duration of the service period, a periodicity of the service period, or any combination thereof.

50. The method of claim 24, wherein the first set of parameters specifies, for at least one service period, at least one type of traffic associated with high priority traffic, time sensitive traffic, or any combination thereof.

51. The method of claim 24, further comprising:
obtaining a first TXOP having a duration based on the at least one boundary.

52. The method of claim 24, further comprising:
obtaining a first TXOP having a duration; and
truncating the duration of the first TXOP based on the at least one boundary.

53. The method of claim 45, wherein the first communication schedule comprises a target wake time (TWT) schedule associated with a service period restriction.

54. The method of claim 45, wherein the first set of parameters indicates, for at least one service period, at least one of: a start time of the at least one service period, a duration of the at least one service period, a periodicity of the at least one service period, or any combination thereof.

55. The method of claim 45, wherein the first set of parameters specifies, for at least one service period, at least one type of traffic associated with high priority traffic, time sensitive traffic, or any combination thereof.
